(19) United States
(12) Patent Application Publication
(10) Pub. No.: US 2025/0200896 A1
(43) Pub. Date: Jun. 19, 2025

(54) COHERENT THREE-DIMENSIONAL PORTRAIT RECONSTRUCTION VIA UNDISTORTING AND FUSING TRIPLANE REPRESENTATIONS

(71) Applicant: NVIDIA Corporation, Santa Clara, CA (US)

(72) Inventors: Koki Nagano, Playa Vista, CA (US); Shengze Wang, Durham, NC (US); Chao Liu, Pittsburgh, PA (US); Shalini De Mello, San Francisco, CA (US); Matthew Aaron Wong Chan, Los Altos, CA (US); Michael Stengel, Hayward, CA (US); Josef Bo Spjut, Durham, NC (US); Xueting Li, Sunnyvale, CA (US)

(21) Appl. No.: 18/971,901

(22) Filed: Dec. 6, 2024

Related U.S. Application Data
(60) Provisional application No. 63/611,853, filed on Dec. 19, 2023.

(51) Int. Cl. G06T 17/20; G06T 13/40; G06V 10/82; G06V 40/16

(52) U.S. Cl. CPC G06T 17/20; G06T 13/40; G06V 10/82; G06V 40/174

(57) ABSTRACT

Systems and methods are disclosed that utilize a triplane fusion architecture that achieves both state-of-the-art three-dimensional (3D) reconstruction accuracy and temporal consistency. For instance, recognizing the need to maintain both coherent identity and dynamic per-frame appearance to enable the best possible realism, the triplane fusion architecture may include an undistorter that removes view-dependent distortions from the raw triplane by using the triplane prior as a reference and a fuser that fuses the triplanes together to recover the occluded areas in the input frame by incorporating features from the triplane prior that is lifted from the frontal reference image. By using the undistorter, the fuser, and a volume renderer, the triplane fusion architecture allows for reconstruction of 3D portrait models from a monocular video stream of a user, which may be useful in various applications including 3D telepresence.

### CLAIM OF PRIORITY

This application claims the benefit of U.S. Provisional Application No. 63/611,853 (Attorney Docket No. 514648) titled “COHERENT 3D PORTRAIT RECONSTRUCTION VIA MEMORY PROPAGATION USING DYNAMIC SYNTHETIC DATA,” filed Dec. 19, 2023, the entire contents of which is incorporated herein by reference.

### BACKGROUND

Telepresence for bringing distant people face-to-face in three-dimensions (3D), stands out as a particularly compelling application of computer vision and graphics, which may be able to transform human experiences. Over the last several decades, various successful telepresence systems have been developed. However, most employ bulky multi-view 3D scanners or depth sensors to ensure high-quality volumetric per-frame reconstruction. Unlike these conventional reconstruction methods, recent artificial intelligence (AI)-based feed-forward 3D lifting techniques, such as Live 3D Portrait (LP3D), may lift a single red, green, blue (RGB) image from an off-the-shelf webcam into a neural radiance field (NeRF) representation in real-time, and pave the path forward towards making 3D telepresence accessible to anyone. Besides democratizing 3D human telepresence, single-frame-based lifting techniques such as LP3D, have the further advantage of faithfully preserving the instantaneous dynamic conditions present in an input video. However, conventional single-image reconstruction methods that operate independently on each frame, are not ideal for maintaining temporal consistency. This difficulty stems from the inherent ill-posed nature of single-image-based reconstruction. For instance, in order to render novel views that are significantly far from the input view, the system cannot rely on information present in the input view and hence must hallucinate plausible content, which cannot be guaranteed to be consistent across multiple temporal frames. This makes the system susceptible to changes in the lifted 3D portrait's appearance, depending on the user's head pose in the input frame.

On the opposite spectrum to single-image-based lifting techniques for telepresence, are 3D self-reenactment methods. 3D reenactment methods create a canonical frame from reference image(s) representing the appearance of the user (usually a mouth closed, frontal neutral frame), and use a separate driving video to control the facial expressions and poses of the avatar. 3D reenactment methods produce temporally consistent results, but do not faithfully reconstruct the input video's dynamic conditions. Moreover, reenactment methods often struggle to authentically reconstruct the accurate expressions of the user because the expression control is not precise enough. Additionally, reenactment methods often fail to reconstruct details not present in the reference image. All of these factors sacrifice realism in 3D reenactment-based methods, making them not ideal for 3D portrait video reconstruction.

As such, there is a need for addressing these issues and/or other issues associated with the prior art.

### SUMMARY

Embodiments of the present disclosure may be used to reconstruct three-dimensional (3D) portrait models from a monocular video stream of a user in single-camera telepresence scenarios, which may be useful in a variety of applications including, but not limited to, 3D reconstruction, 3D avatar digitization, and/or 3D telepresence. For instance, based on an input video from a single-camera source and a reference image of the user, embodiments of the present disclosure may perform coherent 3D portrait reconstruction to synthesize a 3D model of the user. Conventional methods suffer from shortcomings including, but not limited to, relying on target specific priors that require per-user 3D scanning and training, which may be cumbersome and slow, not producing photorealistic renderings, requiring a complex multi-view camera system, and lengthy processing. Complex multi-view camera systems include META'S CODEC AVATAR or GOOGLE STARLINE systems, which uses depth sensors, multi-view cameras, and other devices. These complex multi-view camera systems are expensive and not readily available for end users.

Another conventional method, LP3D, may be a training-free (encoder-based) model that utilizes only a consumer-based web camera; however, LP3D performs 3D lifting per-frame, which leads to temporal inconsistency and distortions especially when the user rotates their head within the input video. As such, embodiments of the present disclosure may utilize an undistorter and/or a fuser along with a reference image to address the limitations of the conventional methods (e.g., LP3D and/or usage a complex multi-view camera system).

In other words, recent breakthroughs in single-image 3D portrait reconstruction have enabled telepresence systems to stream 3D portrait videos from a single camera in real-time, potentially democratizing telepresence. However, per-frame 3D reconstruction exhibits temporal inconsistency and “forgets” the user's appearance. On the other hand, self-reenactment methods may render coherent 3D portraits by driving a personalized 3D prior, but fail to faithfully reconstruct the user's per-frame appearance (e.g., facial expressions and lighting). As such, embodiments of the present disclosure recognize the need to maintain both coherent identity and dynamic per-frame appearance to enable the best possible realism. To this end, embodiments of the present disclosure describe a new fusion-based and/or encoder-based method that fuses a personalized 3D subject prior with per-frame information, producing temporally stable 3D videos with faithful reconstruction of the user's per-frame appearances. For instance, embodiments of the present disclosure may include an encoder-based method that may be trained using synthetic data produced by an expression-conditioned 3D generative adversarial network (GAN), which allows the encoder-based method to achieve both state-of-the-art 3D reconstruction accuracy and temporal consistency on in-studio and in-the-wild datasets.

In an embodiment, a computer-implemented method is provided. The method includes obtaining a reference three-dimensional (3D) representation of a reference image associated with a character and obtaining a raw 3D representation of an input frame from an input video associated with the character. The method further includes processing, using one or more neural networks, the reference 3D representation of the reference image and the raw 3D representation of the input frame to generate a fused 3D representation that recovers occluded areas from the raw 3D representation using the reference 3D representation. The method also includes performing volume rendering on the fused 3D representation to generate an output two-dimensional (2D) image.

### BRIEF DESCRIPTION OF THE DRAWINGS

The present systems and methods for coherent 3D portrait reconstruction via memory propagation using dynamic synthetic data are described in detail below with reference to the attached drawing figures, wherein:

FIG. 1A shows frames generated using conventional methods and frames generated using one or more embodiments of the present disclosure.

FIG. 1B illustrates a block diagram of a general overview of a system comprising a triplane fusion architecture that is suitable for use in implementing one or more embodiments of the present disclosure.

FIG. 2A illustrates a block diagram showing a training phase for the triplane fusion architecture, in accordance with one or more embodiments of the present disclosure.

FIG. 2B illustrates a block diagram of another triplane fusion architecture comprising visibility estimators, in accordance with one or more embodiments of the present disclosure.

FIG. 2C illustrates a block diagram showing a training phase for training the triplane fusion architecture comprising the visibility estimators, in accordance with one or more embodiments of the present disclosure.

FIG. 2D illustrates a block diagram showing a training phase for training the triplane fusion architecture comprising occlusion masks, in accordance with one or more embodiments of the present disclosure.

FIG. 3 illustrates a flowchart of a method for using the triplane fusion architecture, in accordance with an embodiment.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed related to coherent 3D portrait reconstruction via undistorting and fusing 3D representations such as triplane representations. For instance, embodiments of the present disclosure use a triplane fusion method and/or architecture for reconstructing coherent 3D portrait videos by capturing authentic dynamic appearances of user (e.g., facial expressions and lighting) while producing temporally coherent 3D videos. In some examples, embodiments of the present disclosure may achieve high-quality 3D reconstructions and photorealistic renderings from a single image without lengthy processing and/or dependence on target-specific priors.

In an embodiment, the 3D representation may be a hybrid explicit-implicit triplane representation of the 2D image. In an embodiment, the triplane representation is a data structure having dimensions of 256×256×3×32, where each triplane is a 256×256 pixel image comprising 32 channels of feature maps for each of three orthogonal planes (e.g., XY plane, YZ plane, and XZ plane). Of course, in different embodiments, the spatial dimensions in pixels of the feature maps of the tri-plane representation may be increased or decreased, based on the requirements and computational capacity of a given system. Furthermore, the number of feature channels can be less than or greater than 32 channels. The three planes may be used to decode a world-space coordinate in, e.g., <x, y, z> form into a set of features corresponding to that particular coordinate.

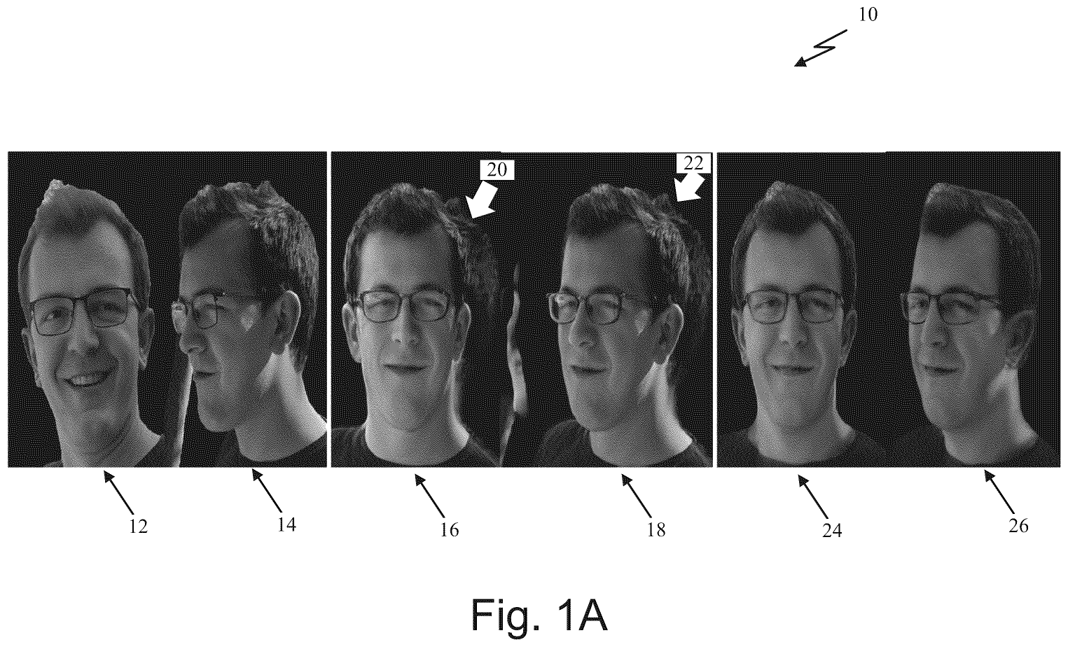

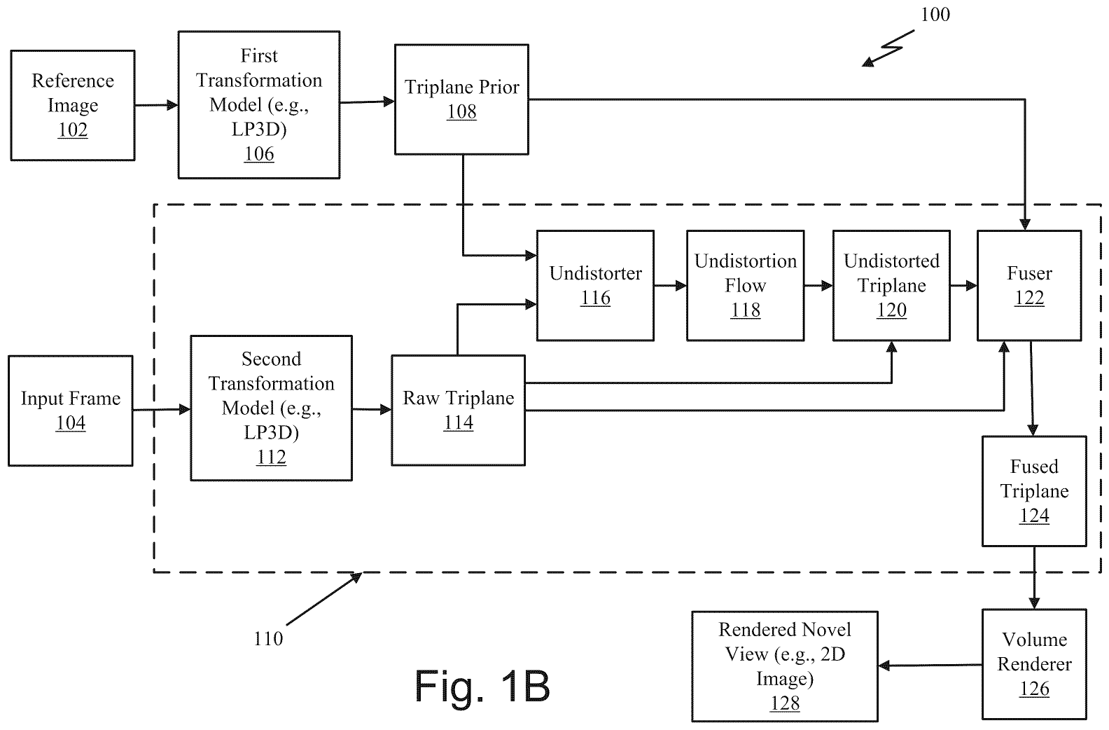

FIG. 1A shows frames generated using conventional methods and frames generated using one or more embodiments of the present disclosure. For example, referring to the images 10 from FIG. 1A, the images 10 include a reference image 12, an input frame 14, frames 16 and 18 that were generated using a conventional method (i.e., LP3D), and frames 24 and 26 that were generated using embodiments of the present disclosure (e.g., using a triplane fusion architecture such as the triplane fusion architecture 110 shown in FIG. 1B). For instance, based on a reference image 12 and an input frame 14, LP3D may be used to generate frames 16 and 18. However, as shown, frames 16 and 18 include inaccuracies (e.g., visual artifacts) 20 and 22. For example, in order to render novel views that are significantly far from the input view (e.g., input frame 14), a system utilizing LP3D is unable to rely on information present in the input frame 14 and hence must hallucinate plausible content, which cannot be guaranteed to be consistent across multiple temporal frames and leads to the inaccuracies 20 and 22. Specifically, when the user rotates their head such as rotating their head to face right as shown by the input frame 14, the right side of the user's face is hidden from the camera. As such, LP3D is unable to rely on the input frame 14 for the right side of the user's face and thus must hallucinate the plausible content, which leads to the inaccuracies 20 and 22.

In contrast to conventional methods such as LP3D, embodiments of the present disclosure utilize a triplane fusion architecture, which uses a reference image 12 and an input frame 14 to generate the frames 24 and 26. As shown by the generated frames 24 and 26, the frames 24 and 26 do not include the inaccuracies 20 and 22 visible in frames 16 and 18. To generate the frames 24 and 26, embodiments of the present disclosure seek to maintain both temporal consistency while preserving real-time dynamics of input videos. Specifically, embodiments of the present disclosure address both problems (e.g., maintaining temporal consistency and preserving real-time dynamics) together for the first time in a single-view 3D portrait synthesis to enable the best user experience. For example, embodiments of the present disclosure solve these problems by employing a fusion-based approach and/or method (e.g., by using a triplane fusion architecture) to achieve these properties. For instance, the triplane fusion architecture described herein may leverage the stability and accuracy of a personalized 3D prior (e.g., the reference image 12), and may fuse the prior (e.g., the reference image 12) with per-frame observations (e.g., the input frame 14) to capture the diverse deviations from the prior.

In some instances, the triplane fusion architecture described by one or more embodiments of the present disclosure may first use an encoder-based model such as a pre-trained LP3D to construct a personal geometric triplane prior from a (near) frontal image of the user, which may be casually or passively captured or extracted from a video. An encoder-based model that may be utilized by embodiments of the present disclosure is described in U.S. patent application Ser. No. 18/472,653, titled “ENCODER-BASED APPROACH FOR INFERRING A THREE-DIMENSIONAL REPRESENTATION OF AN IMAGE,” which is incorporated herein by reference. During video reconstruction, the triplane fusion architecture may use the encoder-based model to lift each input frame into a raw triplane (e.g., triplane representation), which is then fused with the personal triplane prior. When the head pose of the input image is oblique, artifacts and identity distortions may be present in its lifted triplane (e.g., the inaccuracies 20 and 22 shown in frames 16 and 18). Hence, the triplane fusion architecture may use an undistorter module (e.g., the undistorter 116 shown in FIG. 1B), which learns to undistort the raw instantaneous triplane to more closely match the structure of the correctly-structured prior triplane. Then, the triplane fusion architecture may use a fuser module (e.g., the fuser 122), which learns to densely align the undistorted raw triplane to the reference triplane and then fuses the two in a manner that incorporates personalized details such as tattoos or birthmarks present in the reference triplane, while preserving dynamic lighting, expression and posture information from the input raw triplane.

Similar to LP3D, embodiments of the present disclosure may leverage a pre-trained synthetic 3D representation generator (e.g., a 3D generative adversarial network (GAN)) as the generator to synthesize dynamic 3D portraits in both the inference phase as well as the training phase. The 3D GAN may be a Generative Neural Texture rasterization for 3D-Aware Head Avatars (Next3D) model, which is described by Sun et. al, “Next3d: Generative neural texture rasterization for 3d-aware head avatars.” In: IEEE Conference on Computer Vision and Pattern Recognition (CVPR) (2023)) and is incorporated herein by reference. For instance, to train the triplane fusion architecture, embodiments of the present disclosure may use a 3D GAN (e.g., Next3D model), which may thus circumvent the scarcity of real-world 3D portrait data. For example, embodiments of the present disclosure may train the triplane fusion architecture using multi-view images rendered from these dynamic 3D portraits. Further, embodiments of the present disclosure may perform various augmentations during data generation to enhance the synthetic data such that the triplane fusion architecture not only learns from expression changes synthesized by Next3D, but also shoulder rotation and different lighting conditions that cannot be synthesized by the pre-trained generator.

As will be described in more detail below, embodiments of the present disclosure recognize a novel problem to enhance user experiences (e.g., the need to achieve both temporal consistency and reconstruction of dynamic appearances when using single-view 3D lifting solution for telepresence and/or other applications). To solve the problem, embodiments of the present disclosure describe a novel triplane fusion method and/or architecture (e.g., the triplane fusion architecture) that fuses the dynamic information from per-frame triplanes with a personal triplane prior extracted from a reference image. In some instances, the triplane fusion architecture may be trained using a synthetic multi-view video dataset, and the feedforward approach from embodiments of the present disclosure may generate 3D portrait videos that demonstrate both temporal consistency and faithful reconstruction of dynamic appearances (e.g., lighting and expression) of the user at the moment, whereas conventional approaches may only achieve one of the two properties. In some examples, embodiments of the present disclosure describe a new framework to evaluate single-view 3D portrait reconstruction methods using multi-view data. This new framework not only provides accurate evaluation of a method's reconstruction quality by using different viewpoints for evaluation, but also provides insights to a method's robustness by using different viewpoints as inputs. Evaluations on both in-studio and in-the-wild datasets demonstrate that the triplane fusion architecture described by one or more embodiments of the present disclosure achieves state-of-the-art performance in both temporal consistency and reconstruction accuracy.

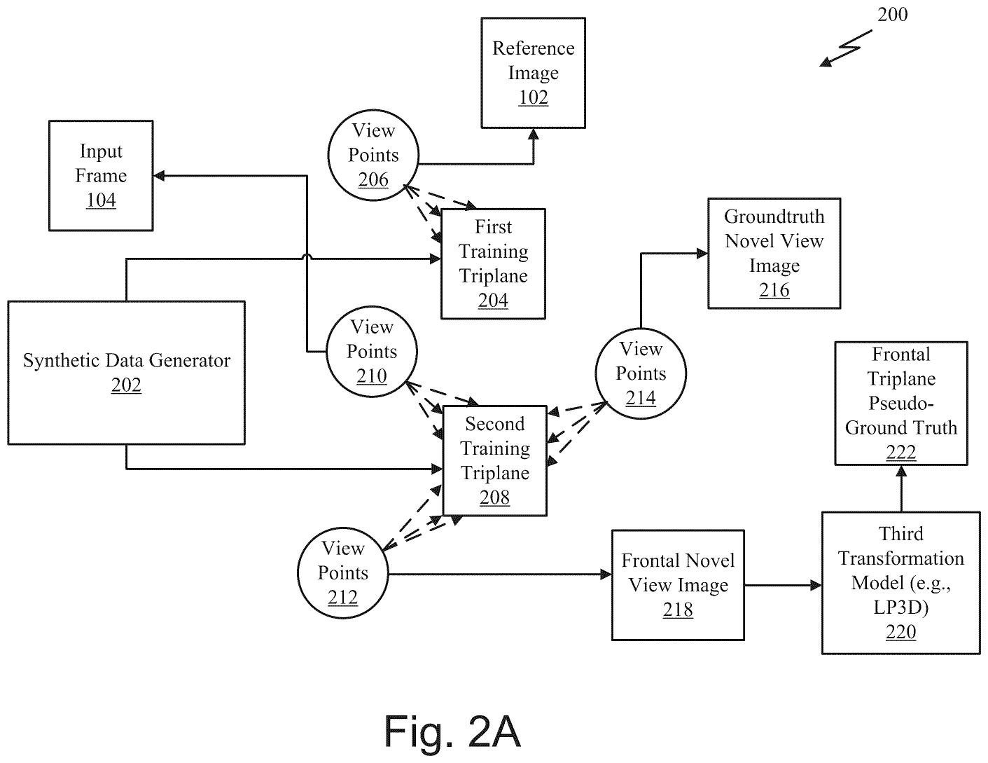

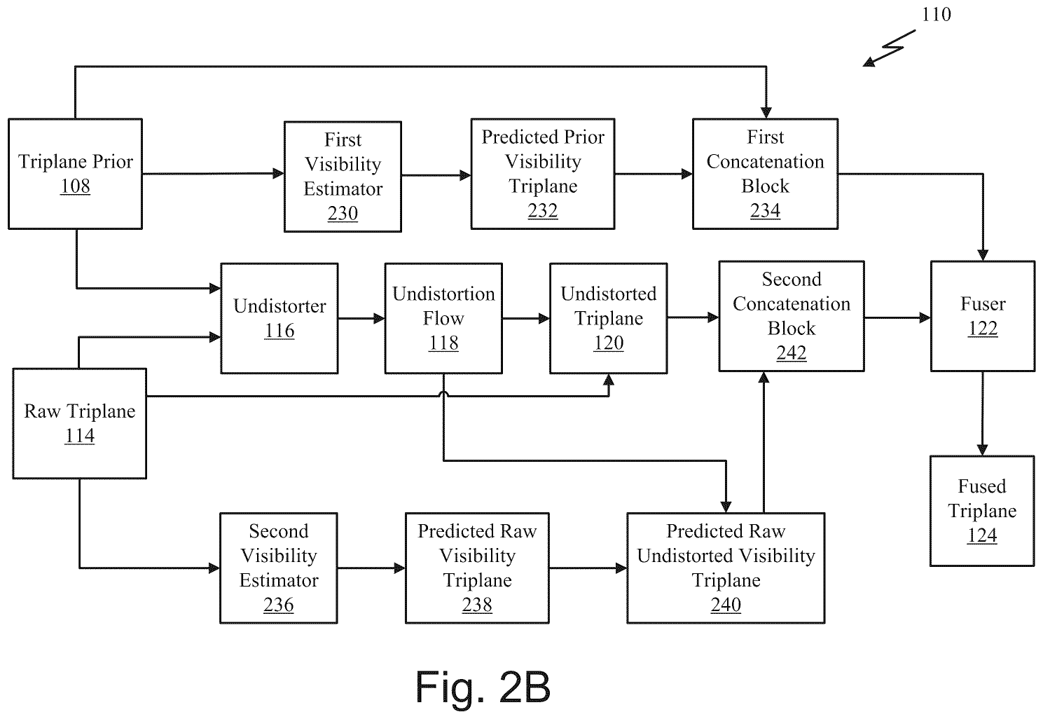

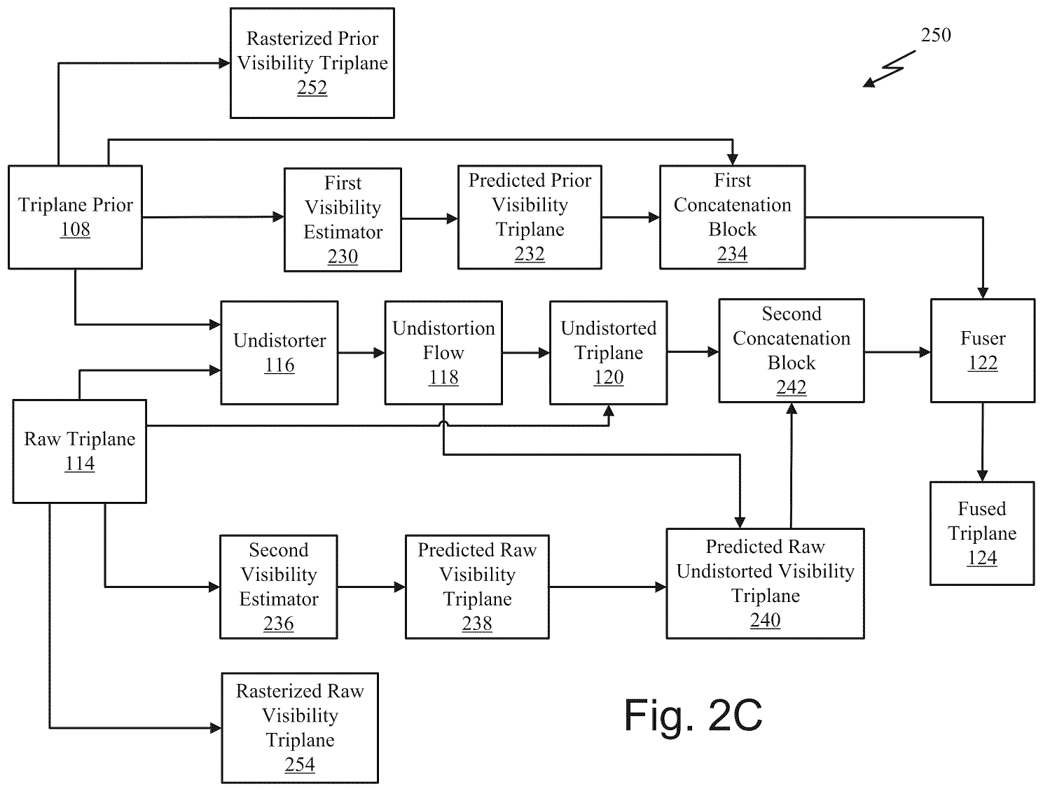

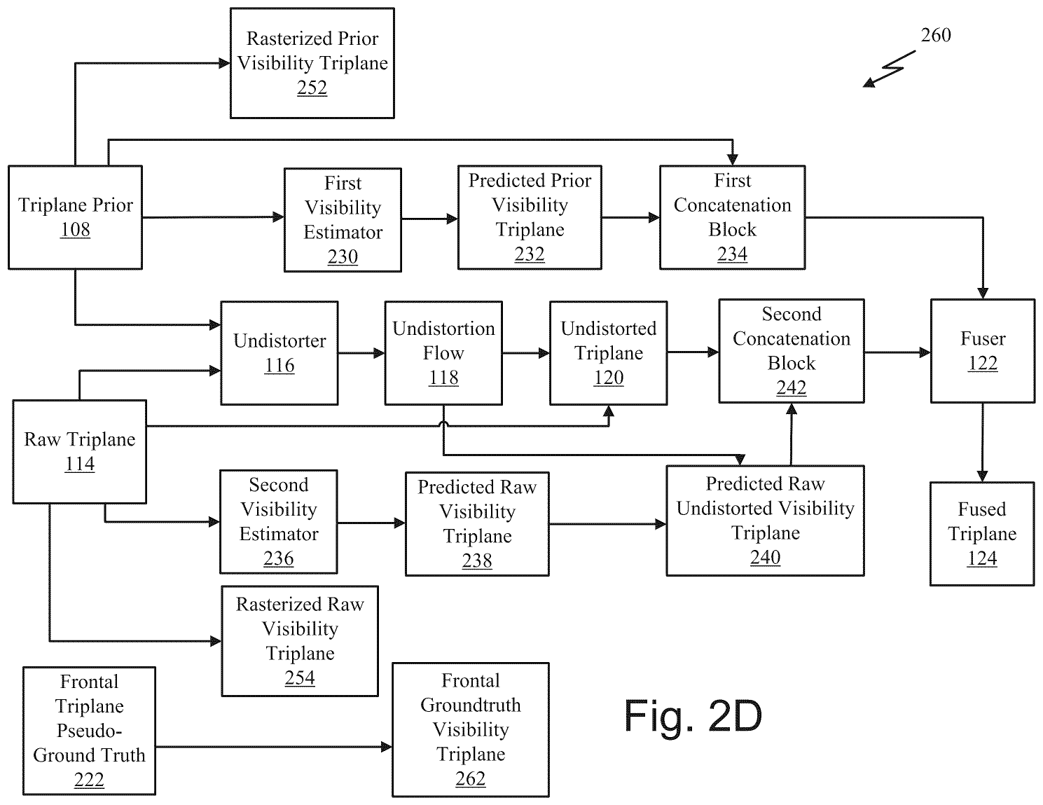

In some embodiments and as used below (e.g., in FIGS. 1B and 2A), an input viewpoint may refer to the viewpoint of the input video relative to the user's head, such as a sensor (e.g., camera) pose. Dynamic appearance or per-frame information may refer to dynamically varying information in a portrait video, such as expressions, lighting condition, and shoulder pose. An input frame (e.g., input frame 104 in FIG. 1A) may refer the current video frame that is being converted into a 3D portrait, and the reference image (e.g., reference image 102 in FIG. 1A) may refer to the image used to capture the prior knowledge of a person (e.g., user), such as a near frontal image. A triplane prior (e.g., the triplane prior 108 in FIG. 1A) may refer to a triplane (e.g., triplane representation) that is reconstructed from the reference image (e.g., reference image 102), and the triplane prior may encode a personalized geometric prior associated with the user. In some embodiments, the frontal images (e.g., the reference image(s) 102) may capture both sides of the user's face and thus may assist with reconstruction when the input frame captures the user from the sides. Dynamic appearance and/or per-frame information may be redefined to emphasize that the fusion process (e.g., the triplane fusion architecture 110 in FIG. 1A) is different from self-reenactment. For instance, the goal of fusion may be to enhance per-frame reconstruction methods with prior information while capturing the authentic dynamic appearance of the user in a video at the same time. In some instances, dynamic appearance may be critical to reconstructing the liveliness of an actual person, whereas reenactment methods focus on driving an avatar instead of reconstructing authentic dynamic appearances in a video.

FIG. 1B illustrates a block diagram of a general overview 100 of a system comprising a triplane fusion architecture 110 that is suitable for use in implementing one or more embodiments of the present disclosure. The overview 100 shows a reference image 102, an input frame 104, a first transformation model (e.g., LP3D) 106, a triplane prior 108, the triplane fusion architecture 110, a volume renderer 126, and a rendered novel view 128. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the overview 100 and/or the triplane fusion architecture 110 is within the scope and spirit of embodiments of the present disclosure.

The general overview 100 shows the inference phase of using a triplane fusion architecture 110 comprising an undistorter 116 (e.g., a first neural network such as a convolutional neural network (CNN)) and a fuser 122 (e.g., a second neural network such as a transformer) to perform 3D reconstruction (e.g., generate a rendered novel view 128). For instance, as will be described in more detail below, embodiments of present disclosure describe a method and triplane fusion architecture 110 that may aim to reconstruct coherent 3D portrait videos from a monocular RGB video without test-time optimization. To improve temporal consistency and reconstruction of occluded areas, the triplane fusion architecture 110 may leverage an additional reference image (e.g., the reference image 102), which may be obtained from the same video or a selfie capture. As shown in the general overview 100, embodiments of present disclosure may first convert an input frame 104 into a raw triplane 114 using a frozen pre-trained transformation model (e.g., an encoder-based model such as an LP3D model or a portion of the LP3D model) 112. Then, the undistorter 116 may remove view-dependent distortions and artifacts by leveraging the triplane prior 108, resulting in an undistorted triplane 120. Further, the fuser 122 may construct the final triplane (e.g., the fused triplane 124) by enhancing the undistorted triplane 120 with additional information from the triplane prior 108. In other words, given a (near) frontal reference image 102 and an input frame 104, a triplane prior 108 and a raw triplane 114 may be reconstructed using transformation models 106 and 112 (e.g., LP3Ds). Next, the two triplanes 106 and 112 may be combined using a triplane fusion architecture 110 comprising an undistorter 116 and a fuser 122. The triplane fusion architecture 110 may ensure temporal consistency while capturing real-time dynamic conditions such as lighting and shoulder pose.

In operation, initially, using a single camera system, a reference image 102 of a user is obtained. The reference image 102 may be a frontal novel view of the user (e.g., an image of the user when the user is facing directly in front of the camera) and may be provided to a first transformation model 106. The first transformation model 106 may be configured to generate a triplane (e.g., triplane representation) based on an input image. In some instances, the first transformation model 106 is an encoder-based model such as an LP3D model, which is described above. In other instances, the first transformation model 106 is another model, process, and/or algorithm. For example, the first transformation model 106 may be any type of model that transforms an image to a 3D representation (e.g., a triplane representation and/or a 3D voxel representation).

As mentioned above, in some examples, the first transformation model 106 may be and/or include an LP3D model and/or part of the LP3D model. For instance, the LP3D model may perform photorealistic 3D portrait reconstruction from a single RGB image. Specifically, the LP3D model may use a feedforward encoder to convert an RGB image into a triplane T∈ [symbol] ^{3×32×256×256}. Here, the dimensions of the triplane T (e.g., triplane representation T) may be defined for three planes (i.e., an xy-plane, an xz-plane, and a yz-plane), and each plane includes channels (C), a height (H), and a width (W). The height (H) and the width (W) (e.g., 256×256) may be associated with the pixel dimensions of the RGB image. Then, LP3D may perform volume rendering to decode the triplane into an RGB image. In some instances, the first transformation model 106 (and the second transformation 112 described below) might not include volume rendering, as volume rendering may be performed afterwards (e.g., volume rendering may be performed by the volume renderer 126 after the triplane fusion architecture 110 generates the fused triplane 124).

During volume rendering, point samples x∈ [symbol] ³ are generated by ray marching from the rendering camera. These point samples may be projected onto each of the three planes (e.g., the xy-plane, xz-plane, and yz-plane), producing bi-linearly interpolated features f_{xy}, f_{xz}, and f_{yz}. The three features may be averaged to produce the mean feature f′, which may be then decoded by a lightweight Multi-Layer Perceptron (MLP) into RGB color c, density σ, and a feature vector f and represented below:

$$( f , c , σ ) = MLP ( {f}^{1401} ) \qquad ( 1 )$$

The point samples may be aggregated together to form pixels through volume rendering, resulting in a low-resolution feature image I_{f}∈ [symbol] ^{32×128×128}. The first three channels of I_{f} are trained to produce an RGB image I_{low} ∈ [symbol] ^{3×128×128} (e.g., a low resolution RGB image having pixel dimensions of 128×128). Finally, a lightweight two-dimensional (2D) convolutional neural network may super-resolve I_{f} into the final rendering (e.g., a high resolution image having pixel dimensions of 512×512):

$$SuperRes ( {I}_{f} ) = {I}_{high} ∈ {ℝ}^{3 \times 512 \times 512} \qquad ( 2 )$$

In some instances, LP3D may leverage synthetic data generated from a pre-trained 3D GAN (e.g., EG3D) and thus circumvents the challenging problem of large-scale 3D groundtruth data acquisition. During training, LP3D may be supervised by both the groundtruth EG3D triplanes as well as the rendered 2D images. As a result of the effectively infinite amount of 2D and 3D groundtruths, LP3D may be able to generate photorealistic 3D portraits. Since LP3D directly maps from images to triplanes via an encoder, LP3D may run in real-time and was thus developed into a complete real-time telepresence system.

In some embodiments, the general overview 100 may include and/or use a modified LP3D model (e.g., the first and/or second transformation models 106 and/or 112 may be a modified LP3D model). For example, the modified LP3D model may be slightly different and improved from the original in that the cropping of the input portrait image may be enlarged to include more of the shoulders, because shoulders may be important for conveying body language and the sense of realism in telepresence. The modified LP3D model may further include an additional camera estimator that takes in LP3D's intermediate features to estimate a set of camera parameters M∈ [symbol] ²⁵. M may represent an estimation of the intrinsic and extrinsic parameters of the camera used to capture the input image. The camera estimator allows the modified LP3D model used by embodiments of the present disclosure to better recreate the input image (e.g., input frame 104) and improve robustness to inaccurate head poses estimated by off—the shelf trackers.

Returning back to the operation of the general overview 100, based on the reference image 102, the first transformation model 106 (e.g., the LP3D model, a modified version of the LP3D model, and/or another encoder-based model) may generate a triplane prior 108 (e.g., a triplane representation of the reference image 102). For example, as mentioned above, the first transformation model 106 may be a portion of an LP3D model, and may use a feedforward encoder to convert an RGB image (e.g., the reference image 102) into a triplane prior 108 (e.g., a triplane representation that has the dimensions 3×32×256×256). The triplane prior 108 may be used as a reference for the input frames 104 of an input video of the user. For instance, as mentioned above, using a transformation model (e.g., the LP3D model) by itself may suffer from lack of temporal consistency. In particular, while the LP3D model may provide an accurate 3D representation of the user when the user is providing a frontal view (e.g., the reference image 102), visual artifacts may appear when the user rotates their head (e.g., the inaccuracies 20 and 22 shown in frames 16 and 18 of FIG. 1A). In other words, when a user rotates their head to the left or right, the single camera may capture frames of only one side of the user's head. Thus, when reconstructing the 3D representation of the user, the LP3D model may extrapolate/hallucinate based on the obscured and/or obstructed information (e.g., the information missing due to only one side of the user's head being captured by the frames). This may cause temporal consistency issues such as artifacts and/or inaccuracies to appear in the 3D representation. As such, embodiments of the present disclosure utilize a triplane fusion architecture 110 that includes an undistorter 116 and a fuser 122 to generate more accurate and complete 3D representations of the user.

For instance, after submitting the reference image 102, an input video may be obtained, and the input frames 104 may be provided to the triplane fusion architecture 110. For example, each input frame 104 may be provided to a second transformation model 112, which may be similar to the first transformation model 112 (e.g., an encoder-based model such as an LP3D model, a portion of the LP3D model, a modified version of the LP3D model, and/or another model that transforms an image to a 3D representation), to generate a raw triplane 114 (e.g., a triplane representation of the input frame 104).

Based on inputting the raw triplane 114 and the triplane prior 108 into the undistorter 116, the undistorter 116 generates an undistortion flow 118, which may then be used to obtain an undistorted triplane 120. Specifically, the undistorter 116 removes view-dependent distortions from the raw triplane 114 by using the triplane prior 108 as a reference (e.g., by estimating warping fields for the raw triplane 114 based on the triplane prior 108). For instance, using the triplane prior 108, the undistorter 116 generates an undistortion flow 118 that predicts the displacement of the raw triplane 114 caused by a view-dependent distortion. In some embodiments, the undistortion flow 118 may be different from a traditional optical flow because a triplane representation includes abstract features that are not typical of RGB images, and thus, optical flow models that are trained on natural images are not sufficient to generate the undistortion flow 118. For example, each plane from the triplane representation may represent 2D features, but may also be combined with other planes from the triplane representation to represent a 3D scene. Thus, unlike traditional optical flow models, the undistorter 116 may be unable to randomly move the pixels from each plane without breaking the 3D representation. Instead, the undistorter 116 may generate the undistortion flow 118 such that the undistortion flow 118 maintains certain consistency across the planes, which would not be possible with the straightforward application of using three iterations of the optical flow model.

In other words, because the objective for an optical flow is to make one triplane (e.g., the raw triplane 114) the same as the other triplane (e.g., the triplane prior 108), if a traditional optical flow model is used, the product would be a triplane that looks very similar to the reference triplane (e.g., the triplane prior 108), but with many artifacts. For example, when aligning an open-mouth triplane to a closed-mouth reference, the open mouth becomes closed, which is not desired. Thus, the undistorter 116 is used to achieve the objective by having the undistorted triplane 120 have the same identity as the reference triplane (e.g., the triplane prior 108), but maintaining the subtle expression (e.g., open-mouth), lighting, and so on of the raw triplane 114. The undistorter 116 may be further trained differently from optical flow, which is described below (e.g., in FIG. 2A).

In some examples, the triplane representations may include three planes, each having the dimensions of height (H) by width (W) by channel (C) (e.g., 256×256×32). In such examples, the undistortion flow 118 may have the dimensions of H×W×2 (e.g., 256×256×2). As such, each entry of the undistortion flow 118 may be associated with a height and width (H×W), and may include two values (e.g., a Δx value and a Δy value). In other examples, instead of the triplane representation being represented by three planes, the triplane representation may be generalized to K-planes, where K does not have to equal three. In other words, the triplane representation may be represented by any number of planes (e.g., three planes, four planes, and so on).

Thus, by applying the undistortion flow 118 to the raw triplane 114, the triplane fusion architecture 110 obtains an undistorted triplane 120 that warps/realigns the raw triplane 114 to remove the distortion. To put it another way, given that only one side of the user's face is shown (e.g., only the left side of the user's face is shown in the input frame 14 of FIG. 1A), the 3D representation indicated by the raw triplane 114 may extrapolate on features of the other side of the user's face, which may cause artifacts and/or stretching to occur (e.g., strong activation on one side of the user's face). By using the undistorter 116 and applying the undistortion flow 118, the raw triplane 114 is warped/transformed such as by displacing the pixels to reduce the stretching within the raw triplane 114. The undistorter 116 may be and/or include a neural network such as a CNN (e.g., an optical flow architecture from a Spatial Pyramid Network (SPyNET)).

In other words, in some embodiments, the triplane fusion architecture 110 uses a frozen pre-trained LP3D to first predict a raw triplane T_{raw} 114 from an input video frame Iᵢₙ (e.g., input frame 104). Even though LP3D excels at faithfully reconstructing the 2D image from the input view, the quality of the actual 3D reconstruction is highly dependent on the person's head pose from the input frame 104. For example, when the user is captured from the sides, LP3D often produces undesired artifacts such as incorrect identity, distortion along the camera's viewing direction, and artifacts on the side of the camera (e.g., the inaccuracies or artifacts 20, 22 from frames 16 and 18 of FIG. 1A).

Visualizing the triplanes may provide more insight to this problem and potential solutions. For instance, when the person (e.g., the user) is captured from the sides, the raw triplanes T_{raw} 114 often exhibit abnormally strong activations on the side being captured, as well as geometric distortion along the view direction of the camera. For example, for a first and second input frame, the camera may capture the user from his left, the LP3D triplanes may show strong activation on the left side of the person, and the triplane and resulting renderings may also be distorted in the horizontal direction. This phenomenon may be ascribed to the inherent ambiguity of single-image reconstruction. At the same time, it was also noticed that LP3D often works well with frontal views, which provides more complete identity information and less occlusion than side views.

Therefore, to reduce the single-image ambiguity, embodiments of the present disclosure may use an encoder-based method (e.g., LP3D) to reconstruct a personal triplane prior Tₚᵣᵢₒᵣ 108 from a frontal image (e.g., reference image 102), and Tₚᵣᵢₒᵣ 108 may be used to constrain reconstructions of subsequent video frames.

In some embodiments, a method to leverage the personal prior (e.g., triplane prior 108) may be to input both the triplane prior 108 and the raw triplane 114 from the current input frame 104 into a neural network (e.g., fuser 122) and rely on large scale training and data to assist the neural network to learn to generate coherent reconstruction. To put it another way, the undistorter 116 may be optional. When the undistorter 116 is not present, the triplane prior 108 and the raw triplane 114 from the current input frame 104 may be input into a neural network (e.g., fuser 122) to generate a fused triplane 124.

In other embodiments, the triplane fusion architecture 110 may include the undistorter 116, which may correct the 3D reconstruction by warping the raw triplane 114. For instance, the undistorter U 116 may learn to correct the raw triplane T_{raw} 114 using the triplane prior Tₚᵣᵢₒᵣ 108 as a reference and may produce an undistorted triplane T_{undist} 120:

$$U ( {T}_{raw} , {T}_{prior} ) = {T}_{undist} ∈ {ℝ}^{3 \times 32 \times 256 \times 256} . \qquad ( 3 )$$

In some embodiments, the undistorter U 116 may be based on the optical flow architecture from SPyNet. For instance, SPyNet was originally developed to estimate dense optical flow to warp a source RGB image I_{src} to a target image I_{tgt} by iteratively estimating warping fields in a coarse-to-fine fashion. The same architecture may be effective in predicting an undistortion flow map T_{flow} ∈ [symbol] ^{3×32×256×256} (e.g., the undistortion flow 118) that reduces the distortion in T_{raw} 114:

$${T}_{flow} = SPyNet ( {T}_{raw} , {T}_{prior} ) , \qquad ( 4 )$$

$${T}_{undist} = Warp ( {T}_{raw} , {T}_{flow} ) . \qquad ( 5 )$$

For instance, the undistorter 116, which may be partially based on SPyNet, may take T_{raw} 114 and Tₚᵣᵢₒᵣ 108, and generate T_{flow} 118. Then, the undistorter 116 may take T_{flow} 118 and T_{raw} 114, and perform a warping operation to generate the undistorted triplane T_{undist} 120.

As mentioned above, the undistortion process performed by the undistorter 116 might not be the same as optical flow prediction. For instance, while a flow estimator would predict a flow that aligns the two inputs, the undistorter 116 does not align the two inputs, i.e., the undistorter 116 does not warp T_{raw} 114 to Tₚᵣᵢₒᵣ 108 or vice versa. Instead, the undistorter 116 merely uses Tₚᵣᵢₒᵣ 108 as the conditioning input to predict a correction warping to T_{raw} 114, producing T_{undist} 120. T_{undist} 120 may be supervised by the pseudo-groundtruth triplane T_{triplaneGT} via a triplane loss:

$${L}_{undist} = {L}_{1} ( {T}_{undist} , {T}_{triplaneGT} ) . \qquad ( 6 )$$

The triplane loss L_{undist} and the training for the triplane fusion architecture 110 will be described in further detail in FIG. 2A.

Moving forward, after obtaining the undistorted triplane 120, the triplane fusion architecture 110 may use a fuser 122. For instance, the raw triplane 114, the triplane prior 108, and the undistorted triplane 120 are input into the fuser 122 (e.g., a transformer such as a recurrent video restoration transformer (RVRT)) to generate a fused triplane 124. For example, the fuser 122 may fuse the three triplanes 108, 114, and 120 to recover the occluded areas in the input frame 104 by incorporating the triplane prior 108 that is lifted from the frontal reference image 102. For instance, the occluded areas of the raw triplane 114 are typically visible in the frontal images (e.g., reference image 102) and the triplane prior 108, and thus by fusing the three triplanes 108, 114, and 120, the fuser 122 generates a fused triplane 124 for the input frame 104 that undistorts the raw triplane 114 and further utilizes the occluded areas of the raw triplane 114 that are shown in the triplane prior 108.

In other words, as the user moves around in the video, different parts of their head may become occluded. To recover occluded areas in the input frame 104 and further stabilize the subject's identity across the video, the fuser 122 may enhance the reconstruction by incorporating a personal triplane prior Tₚᵣᵢₒᵣ 108 lifted from a frontal reference image 102. Triplane priors Tₚᵣᵢₒᵣ 108 may be essential because the currently occluded areas are often visible in frontal images (e.g., reference image(s) 102) and Tₚᵣᵢₒᵣ 108, and frontal images may also provide rather complete information about the person's identity and facial geometry, which may be beneficial for stable identity reconstruction. Both the undistorted triplane T_{undist} 120 and the triplane prior Tₚᵣᵢₒᵣ 108 are fed to the triplane fuser 122 to produce the final fused triplane T_{fused} 124.

In some embodiments, due to the memory efficiency of RVRTs, the fuser 122 may be and/or include an RVRT and/or a modified RVRT. For instance, the modified RVRT may replace the final summation skip connection with a convolutional skip connection because the summation skip connection may prevent effective learning. This may be because the original RVRT was designed to correct local blurriness and noises in a corrupted RGB video, whereas triplane videos exhibit structural distortion on a much larger scale and the summation skip connection may thus limit the triplane fusion architecture's 110 ability to correct the general structure. Thus, the fuser 122 may be an RVRT that replaces the summation with a small 5-layer convolutional network (ConvNet).

In some embodiments, both the undistorter U 116 and the fuser F 122 may include and/or use three separate, but identical fusers for each of the three planes of the triplanes 108, 114, and 120. For instance, in some variations, using a single network (e.g., a single fuser 122) to process all three planes may cause collapse to 2D, and thus, the triplane architecture 110 may use three separate fusers 122.

In some embodiments, to generate the fused triplane 124, the triplane fusion architecture 110 may include and/or use additional elements such as visibility predictors and/or occlusion masks. The visibility predictors and/or occlusion masks are described in further detail in FIGS. 2B and 2C.

After obtaining the fused triplane 124, volume renderer 126 is used to render a novel view 128. For example, the volume renderer 126 may be a neural renderer, which may include a decoder (e.g., a MLP network) with one or more fully connected layers trained to convert the fused triplane 124 into color and/or density information. An example neural render is described in additional detail in U.S. patent application Ser. No. 18/472,653 and in Chan et al. in “Efficient Geometry-aware 3D Generative Adversarial Networks,” Computer Vision and Pattern Recognition (CVPR), 2022, which are incorporated herein by reference. In some embodiments, the neural render may be a 3D Gaussian Splatting, which is described in “3D Gaussian Splatting for Real-Time Radiance Field Rendering,” arXiv: 2308.04079 (2023) and is incorporated herein by reference.

As such, by using the triplane fusion architecture 110 and the first transformation model 106, the system is configured to generate a 3D representation of a character (e.g., person and/or user) from the input frame 104 (e.g., a 2D image). Then, using the 3D representation, the volume rendering 126 generates a rendered novel view 128 such as an output image from an arbitrary pose. For instance, the pose may include a number of intrinsic and/or extrinsic parameters related to a camera position and orientation as well as other camera parameters, and using the 3D representation, the output image may show the character in different poses.

In some examples, in addition to using the reference image 102 of the frontal view of the user, the triplane fusion architecture 110 may use one or more additional input views such as side views of the user. In an embodiment, the triplane fusion architecture 110 may use the multiple reference views (e.g., the frontal view as well as the side views of the user) for the undistorter 116, to generate the fused triplane 124, and/or to generate the rendered novel view 128.

FIG. 2A illustrates a block diagram 200 showing a training phase for the triplane fusion architecture 110 (e.g., the undistorter 116 and the fuser 122) in accordance with one or more embodiments of the present disclosure. For instance, the synthetic data generator 202 generates animated 3D portraits (e.g., the first triplane 204 and the second triplane 208) as groundtruth training data that is then used to train the undistorter 116 and the fuser 122 from the triplane fusion architecture 110 of FIG. 1B. For example, in some embodiments, the synthetic data generator 202 includes a random vector generator (e.g., a style code), animated mesh generator (e.g., a Faces Learned with an Articulated Model and Expressions (FLAME) model), and a synthetic 3D representation generator (e.g., a Next3D model). For instance, the random vector generator, such as a style code, may generate a random vector of numbers (e.g., a vector of 128 elements and each element is randomized between −1 and 1). The animated mesh generator may generate two meshes (e.g., a first mesh (t=0) and a second mesh (t=1)). These meshes depict a different expression (e.g., expressions indicated by t=0 or t=1) of the same synthetic person or character. For example, the animated mesh generator may be a FLAME model that generates coefficients (e.g., pose coefficients, shape coefficients, and expression coefficients) indicating a synthetic mesh of a person's facial features and landmarks of the person (e.g., identifying features within an image of the person's facial features such as eyes, mouth, and so on). A random sample of FLAME coefficients and landmarks as well as a style code are input into the synthetic 3D representation generator (e.g., the Next3D model) to generate first and second training triplanes 204 and 208. For instance, a first random sample of FLAME coefficients/landmarks and a first style code may be input into the synthetic 3D representation generator to generate the first training triplane 204. Then, a second random sample of FLAME coefficients/landmarks and a second style code may be input into the synthetic 3D representation generator to generate the second training triplane 208.

In other words, at each training iteration, different viewpoints of the same person may be rendered, but with different expressions. Since the style code controls the identity of the generated person, only one style code may be used for each training iteration/sample. Thus, at each iteration, there is one style code and two expressions that are used (e.g., two triplanes 204 and 208 are generated). The first expression (e.g., triplane 204) may be always rendered to generate a frontal image (e.g., the reference image 102) and may be used as the reference image that is input into the triplane fusion architecture 110. The second triplane 208 may be rendered from multiple viewpoints: 1) one shot from the front to obtain frontal novel view image 218, and the resulting image may be passed through the third transformation model 220 to generate the pseudo-ground truth frontal triplane 222; 2) one or more images from any other viewpoint 214 to obtain the ground truth novel view image 216, and these images may be used as the groundtruth for the final rendering (e.g., after the fused triplane 124 is volume rendered to generate the rendered novel view 128). The usage of the triplanes 204 and 208 is described in further detail below. The above description of the synthetic data generator 202 and the elements the synthetic data generator 202 are merely an example, and other synthetic data generators 202 with different elements may be used to generate the training triplanes 204 and 208.

In other words, inspired by LP3D and the development of 3D GANs, in some embodiments, the synthetic data generator 202 may include a Next3D model that is used to generate animated 3D portraits (e.g., the first and second training triplanes 204 and 208) as groundtruth training data. During data preparation, a first dataset (e.g., a Flickr-Faces-HQ (FFHQ) dataset) may be preprocessed into facial landmarks and FLAME coefficients using a Detailed Expression Capture and Animation (DECA) model. During the training of the triplane fusion architecture 110, a pair of FLAME coefficients and landmarks may be randomly sampled based on the pre-processed dataset and a single style code corresponding to a random identity. The sampled data may be input into a Next3D model to generate a pair of triplanes for t=0 and t=1 (e.g., training triplanes 204 and 208), each depicting a different expression of the same synthetic person. The triplane for t=0 (e.g., the first training triplane 204) may be used to render the reference image 102 from a frontal viewpoint. The triplane for t=1 (e.g., the second training triplane 208) may be used to render the input frame 104, the frontal novel view image 218 (used for supervision), and the groundtruth image (e.g., the groundtruth novel view image 216) for the sampled novel viewpoint (e.g., viewpoints 214). The groundtruth novel view image 216 and the frontal novel view image 218 may be used for supervision of the triplane fusion architecture 110.

The training of the triplane fusion architecture 110 will be described in further detail below. For instance, after obtaining the first and second training triplanes 204 and 208, different viewpoints 206 and 210-214 (e.g., poses and/or camera angles) may be taken using the training triplanes 204 and 208 to generate 2D images. For example, during each iteration of the training, different viewpoints or camera angles from the first and second training triplanes 204 and/or 208 may be taken and used to determine losses within the triplane fusion architecture 110. The losses may then be used to update the weights/parameters of the undistorter 116 (e.g., a neural network such as a CNN) and the fuser 122 (e.g., a transformer) via backpropagation and/or other training techniques to train the undistorter 116 and the fuser 122.

For example, the viewpoints 206 may be a frontal view point of the first training triplane 204. Using the viewpoints 206 and volume rendering, which is described above, a reference image 102 may be obtained. Then, viewpoints 210 may be randomized such that different poses/camera angles are taken of the second training triplane 204. Using the viewpoints 210 and volume rendering, an input frame 104 may be obtained. Referring back to FIG. 1B, the reference image 102 and the input frame 104 are then used with the triplane fusion architecture 110 to generate aspects such as the undistorted triplane 120, the fused triplane 124, and the rendered novel view 128.

In addition to the outputs from the triplane fusion architecture 110, the viewpoints 212 and 214 are used to determine the groundtruths/pseudo-groundtruths. For example, as mentioned previously, conventional methods such as LP3D may provide substantially accurate results if provided input of a frontal novel view. As such, the viewpoints 212 obtain a frontal novel view of the second training triplane 208, and using volume rendering, generates a frontal novel view image 218. The frontal novel view image 218 is provided to a third transformation model 220, which may be similar to the first/second transformation models 106 and 112 described above (e.g., an LP3D and/or a modified LP3D), to obtain a frontal triplane pseudo-ground truth 222. The frontal triplane pseudo-ground truth 222 may be a pseudo-ground truth because LP3D may have only viewed the front of the person's head, and the side of the face (e.g., side triplanes) may be hallucinated and may differ from frame to frame.

Furthermore, similar to viewpoint 210, the viewpoint 214 is randomized, and using volume rendering, a groundtruth novel view image 216 is obtained. In some instances, to learn to fuse images under different lighting conditions, two separate color space augmentations are applied to the images at t=0 and t=1 (e.g., images generated using the first and second training triplanes 204 and 208 such as the images/frames 102, 104, 216, and/or 218), each involving random alterations to brightness, contrast, saturation, and/or hue. For example, the same color space augmentations may be applied to images having the same expression, but a second color space augmentation may be applied to images that have different expressions. For instance, images 104, 216, and 218 may have the same augmentation, but image 102 may have a different augmentation.

After obtaining the results described above, the loss function below is used that provides two types of supervision: (a) direct triplane space guidance that is used to supervise the undistortion process in the undistorter 116 and the fusion process in the fuser 122; and (b) image space guidance for overall learning of high-quality image synthesis. The loss function is provided below:

$$L = {w}_{undistr} {L}_{undistr} + {w}_{fusion} {L}_{fusion} + {w}_{render} {L}_{render} \qquad ( 7 )$$

In the above loss function, w_{undistr} is a scalar weight applied for the undistortion, w_{fusion} is a scalar weight applied to the fusion, and w_{render} is a scalar weight applied for the rendering. Further, L_{undistr}, which is shown in Equation (Eq.) 6 above, is a loss that is determined based on a comparison of the undistorted triplane 120 and the frontal triplane pseudo-groundtruth 222. L_{fusion} is a loss that is determined based on a comparison of the fused triplane 124 and the frontal triplane pseudo-groundtruth 222. L_{render} is a loss that is determined based on the rendered novel view 128 and the groundtruth novel view 216. As such, using the loss function/losses as well as an optimization algorithm, the weights/parameters of the undistorter 116 and the fuser 122 are updated.

Then, further iterations of the training process are performed such as generating the reference image 102, input frame 104, the groundtruth novel view 216, and frontal triplane pseudo-ground truth 222, and using the generations and the above loss function to train the undistorter 116 and the fuser 122. In some embodiments, the first, second, and third transformation models 106, 112, and 220 are frozen during both the training and inference phases.

In some examples, L_{fusion} is a fusion loss that is used to supervise the fuser 122. The fusion loss may be calculated as the L₁ loss between the fused triplane T_{fused} 124 and the pseudo-groundtruth triplane T_{frontalGT} 222. In some instances, L_{render} may be calculated as the perceptual loss L_{LPIPS} between the groundtruth novel view image I_{GT} 216 and the rendered novel view image I_{render} 128. The calculation of L_{render} is shown below:

$${L}_{render} = {L}_{LPIPS} ( {I}_{GT} , {I}_{render} ) \qquad ( 8 )$$

In some variations, as mentioned above, the training of the undistorter 116 may be different from the training for the optical flow. For instance, an optical flow model may be trained by warping the raw triplane 114 to be the same as the triplane prior 108. This is shown in the below representation:

$${T}_{prior} = Warp ( {T}_{raw} , Flow ( {T}_{raw} , {T}_{prior} ) ) . \qquad ( 9 )$$

However, for training the undistorter 116 and as described above, the frontal triplane pseudo-ground truth T_{frontalGT} 222 is used as the groundtruth rather than the triplane prior 108. This is shown in the below representation:

$${T}_{frontalGT} = Warp ( {T}_{raw} , Flow ( {T}_{raw} , {T}_{prior} ) ) . \qquad ( 10 )$$

where the frontal triplane pseudo-ground truth 222 is used as the groundtruth triplane with no distortion, and the frontal triplane pseudo-ground truth 222 is not equal to the triplane prior 108, because they may have different expressions/lighting/shoulder poses).

In some embodiments, during the training phase, pose augmentation (e.g., shoulder augmentation) may also performed. For example, 3D portraits may include shoulders for improved realism and inclusion of body language. Thus, during the training phase, the synthetic data generator 202 may generate the first and second training triplanes 204 and 208 of a same person with various shoulder rotations. However, as some synthetic 3D representation generators (e.g., a Next3D model) do not provide control over shoulder rotations, the training phase may perform shoulder rotation augmentation during volume rendering. For example, the camera rays may be warped during volume rendering to simulate shoulder movement in the rendered image without having to modify the first and second training triplanes 204 and 208. Thus, using this augmentation, various shoulder poses may be rendered in 2D images without modifying the training triplanes 204 and 208.

To put it another way, as mentioned above, to generate the images 102, 104, 216, and 218 from viewpoints 206 and 210-214, volume rendering may be performed. In some embodiments, to perform shoulder augmentation, during volume rendering to generate the images 102, 104, 216, and/or 218 from viewpoints 206, 210, 212, and/or 214, the camera rays may be warped to simulate shoulder movement in the rendered image. For example, during volume rendering, a set of 3D points may be selected in the 3D space. When performing shoulder augmentation, two aspects are performed: 1) for “shrugs,” the 3D selected 3D points may be moved (e.g., by rotating them around the top of the neck, heuristically set as origin 0, 0, 0) such that one side of the shoulder moves upwards, and the other side moves downwards; 2) for side rotations, the 3D points may be moved (e.g., rotation around the origin, but in the horizontal plane) such that the shoulder rotates sideways with respect to the head (e.g., similar to if the person is saying “no, no, no”). The augmentations may then be used to train the triplane fusion architecture 110 (e.g., the images 102, 104, 216, and/or 218 may be used along with the loss function described in Eq. 7 to train the triplane fusion architecture 110).

In other words, it may be important that 3D portraits include shoulders for improved realism and inclusion of body language in telepresence. In order for the triplane fusion architecture 110 to learn to fuse images with different shoulder poses, synthetic data of the same person with various shoulder rotations may be generated. However, Next3D does not provide control over shoulder rotation, and it may be difficult to manipulate triplanes due to their implicit nature. Therefore, shoulder rotation augmentation may be performed during volume rendering. For instance, camera rays may be warped during volume rendering to simulate shoulder movement in the rendered image without having to modify the Next3D triplane (e.g., triplanes 204 and 208). Through this augmentation, various shoulder poses in rendered 2D images may be synthesized without modifying the Next3D triplane.

In some embodiments, as a result of the shoulder augmentation, the 2D renderings (e.g., the ground novel view image 216 and/or the frontal novel view image 218) may involve changes that are not present in the original Next3D triplanes (e.g., in the first and second training triplanes 204 and 208). By not being present, this may indicate that the training triplanes 204 and 208 cannot be used as direct supervisory signals. On the other hand, LP3D often generates reasonably accurate triplanes on frontal view images. Therefore, to provide direct supervision signals to both the undistorter 116 and the fuser 122, a frozen LP3D (e.g., the third transformation model 220) may be used to predict pseudo-groundtruth triplanes (e.g., the frontal triplane pseudo-ground truth 222) from the frontal novel view of t=1 (e.g., the second training triplane 208).

In some embodiments, as mentioned above, the triplane fusion architecture may include and/or use additional elements such as visibility predictors and/or occlusion masks. This will be described in FIGS. 2B and 2C below. For instance, FIG. 2B illustrates a block diagram of another triplane fusion architecture 110 comprising visibility estimators 230 and 236, in accordance with one or more embodiments of the present disclosure. For instance, referring to FIG. 2B, after obtaining the triplane prior 108 and the raw triplane 114, the triplanes 108 and 114 may be fed to the undistorter 116 to generate the undistortion flow and determine the undistorted triplane 120, which is described above.

In addition, two visibility estimators 230 and 236 are included in the triplane fusion architecture 110, and the two visibility estimators 230 and 236 determine predicted prior and raw visibility triplanes 232 and 238 from the triplane prior 108 and the raw triplane 114. For example, it may be important that the fuser 122 attempt to preserve the visible information in the input frame 104 in order to accurately reconstruct dynamic conditions such as lighting changes. For instance, as mentioned above, the user may rotate their head to the right (e.g., shown in frame 14 of FIG. 1A), and thus while the right side of the user's face is not visible, the left side of the user's face is still visible. In order to accurately reconstruct dynamic conditions such as lighting changes, the triplane fusion architecture 110 may include visibility estimators 230 and 236 that are used to preserve the visible information in the input frame 104 (e.g., the lighting changes and/or the left side of the user's face). For instance, the visibility estimators 230 and 236 may determine visibility maps (e.g., a 3D visibility maps) for the triplane prior 108 (e.g., a visibility map indicating visible regions of the user's face from the reference image 102) and for the raw triplane 114 (e.g., a visibility map indicating visible regions of the user's face from the input frame 104). For example, by estimating a visibility triplane Tᵥᵢₛ^{raw}∈ [symbol] ^{3×128×128} (e.g., predicted raw visibility triplane 238) for T_{raw} 114 (e.g., one visibility map for each plane) using the second visibility estimator 236, a 3D visibility map for the input frame 104 may be predicted. In some embodiments, the first and second visibility estimators 230 and 236 may be and/or include a ConvNet such as a 5-layer ConvNet. In some embodiments, the first and second visibility estimators 230 and 236 may be the same model instance.

In other words, the LP3D models may generate a complete triplane (and thus 3D portrait) from a single image, which may inevitably include occlusion. For example, when the camera captures the person from the right, the right side of the face is visible and thus more reliable in the reconstruction whereas the left side of the face is occluded and thus is often inaccurately hallucinated by the LP3D models. Therefore, to fuse reliable information from the input frame (e.g., the raw triplane T_{raw} 114) and the reference image (e.g., the triplane prior Tₚᵣᵢₒᵣ 108), it may be important to inform the fuser 122 about visible (and thus reliable) regions on the two triplanes 108 and 114.

As such, in FIG. 2B, the visibility information (e.g., the predicted raw visibility triplane 238 and the predicted prior visibility triplane 232) may be predicted and/or leveraged by the triplane fusion architecture 110 and the fuser 122 to generate a more accurate fused triplane 124. For instance, the second visibility estimator 236 may be provided to the raw triplane 114, and using the raw triplane 114, the second visibility estimator 236 may generate a predicted raw visibility triplane Tᵥᵢₛ^{raw} 238 for the raw triplane 114. Further, the visibility triplane 238 may be undistorted alongside the undistorted triplane T_{undist} 120 using the undistortion flow T_{flow} 118 to generate the predicted raw undistorted visibility triplane Tᵥᵢₛ^{undist} 240. The predicted raw undistorted visibility triplane Tᵥᵢₛ^{undist} 240 may inform the fuser 122 about the visibility/reliability of different regions in the undistorted triplane T_{undist} 120 and may allow for better fusion.

Similarly, the first visibility estimator 230 may be provided to the triplane prior 108, and using the triplane prior 108, the first visibility estimator 230 may generate a predicted prior visibility triplane Tᵥᵢₛ^{prior} 232 for the triplane prior 108. Then, using the first and concatenation blocks 234 and 242, the triplanes may be concatenated and provided to the fuser 122. For example, the triplane prior 108 and the predicted prior visibility triplane 232 may be input into the first concatenation block 234 to generate a first concatenation that is provided to the fuser 122. Further, the undistorted triplane 120 and the predicted raw undistorted visibility triplane 240 may be input into the second concatenation block 242 to generate a second concatenation that is provided to the fuser 122. Based on the two concatenations, the fuser 122 generates the fused triplane 124. Following, the process continues as described in FIG. 1B to generate the rendered novel view 128.

In some instances, to determine the visibility information for a triplane, a rasterization approach may be used. For instance, given a triplane T and the triplane's input camera pose C, a visibility triplane (e.g., triplanes 232 and/or 238) may be generated by first rendering the triplane (e.g., triplane prior 108 and/or raw triplane 114) into a depth map via volume rendering from camera C, then lifting the depth map into 3D point clouds, and rasterizing the point cloud back onto the triplane by orthographically projecting the points onto the three planes of the triplane. However, because the rasterization approach may be expansive due to the volumetric rendering used for depth map generation, in some embodiments, the first and second visibility estimators 230 and 236 may be used to predict and/or determine the triplanes 232 and/or 238. For instance, the first and second visibility estimators 230 and 236 may be a 5-layer ConvNet that predicts the visibility maps Tᵥᵢₛ^{prior}, Tᵥᵢₛ^{raw} ∈ [symbol] ^{3×1×128×128} from the triplane prior Tₚᵣᵢₒᵣ 108 and the raw triplane T_{raw} 114. The two visibility maps (e.g., the predicted raw undistorted visibility triplane 238 and the predicted prior visibility triplane 232) are concatenated with the triplane prior Tₚᵣᵢₒᵣ 108 and the undistorted triplane T_{undist} 120 using the first and second concatenation blocks 234 and 242 before being input into the fuser 122. In other words, T_{raw} 114 and T_{raw} 238 are concatenated and undistorted together using the undistortion flow 118 and the second concatenation block 242 before being input to the fuser 122 alongside Tₚᵣᵢₒᵣ 108 and its visibility triplane Tᵥᵢₛ^{prior} 232. In this way, the fuser 122 preserves visible facial regions in T_{raw} 114 and may recover the occluded regions using the triplane prior Tₚᵣᵢₒᵣ 108.

To train the first and second visibility estimators 230 and 236, rasterized raw and prior visibility triplanes may be used. FIG. 2C illustrates a block diagram 250 showing a training phase for training the triplane fusion architecture 110 comprising the visibility estimators 230 and 236, in accordance with one or more embodiments of the present disclosure. For instance, as mentioned above, a rasterization approach may be used to determine the visibility information for a triplane. During the training phase, the rasterization approach is used to generate the rasterized prior visibility triplane 252 from the triplane prior 108 and the rasterized raw visibility triplane 254 from the raw triplane 114. For example, given the triplane prior 108 and the triplane prior's input camera pose, a pseudo-ground truth visibility triplane (e.g., the rasterized prior visibility triplane T_{visGT}^{prior} 252) may be generated. For instance, first, the prior triplane 108 may be rendered into a depth map via volume rendering from camera C. Then, the depth map may be lifted into 3D point clouds and the point cloud may be rasterized back to generate the rasterized prior visibility triplane T_{visGT}^{prior} 252 by orthographically projecting the points onto the three planes of the triplane 252. The final visibility mask is “1” where points are rasterized and “0” where none is rasterized. Similarly, given the raw triplane 114 and the raw triplane's input camera pose, a pseudo-ground truth visibility triplane (e.g., the rasterized raw visibility triplane T_{visGT}^{raw} 254) may be generated.

After generating the rasterized prior visibility triplane 252 and the rasterized raw visibility triplane 254, a visibility loss Lᵥᵢₛ may be calculated and used to update the visibility estimators 230 and 236. For example, the visibility loss Lᵥᵢₛ may be the L₁ distance between the predicted visibility triplanes (Tᵥᵢₛ^{raw} 238 and Tᵥᵢₛ^{prior} vis 232) and the groundtruth visibility triplanes (T_{visGT}^{raw} 254 and T_{visGT}^{prior} 252). The calculation of Lᵥᵢₛ may be represented below:

$${L}_{vis} = {L}_{1} ( {T}_{vis}^{raw} , {T}_{visGT}^{raw} ) + {L}_{1} ( {T}_{vis}^{prior} , {T}_{visGT}^{prior} ) \qquad ( 11 )$$

In an embodiment, the predicted visibility triplane Tᵥᵢₛ^{raw} 238 may be a prediction obtained from the second visibility estimator 236 and the visibility triplane T_{visGT}^{raw} 254 may be the groundtruth. In other words, the predicted visibility triplane Tᵥᵢₛ^{raw} 238 (e.g., predicted by a network such as the second visibility estimator 236) may be an approximation of the groundtruth T_{visGT}^{raw}, 254, which may be rasterized. The other visibility triplanes and visibility groundtruth triplanes may be computed similarly. In other words, the groundtruth visibility map may be expensive to compute, and therefore the visibility map may instead be predicted rather than calculated.

The loss function utilized by the triplane fusion architecture 110 may be modified based on incorporating the visibility loss Lᵥᵢₛ for the visibility estimators 230 and 236. For instance, the modified loss function may be represented below:

$$L = {w}_{undist} {L}_{undist} + {w}_{vis} {L}_{vis} + {w}_{fusion} {L}_{fusion} + {w}_{render} {L}_{render} . \qquad ( 12 )$$

The modified loss function includes similar terms as described in Eq. 7 above, but further includes wᵥᵢₛ, which is a scalar weight for the visibility loss, and the visibility loss Lᵥᵢₛ, which is described in Eq. 11 above. As such, the modified loss function may provide a supervision to direct triplane space guidance used to supervise the undistortion process in the undistorter 116, the visibility prediction process for the visibility estimators 230 and 236, and the fusion process in the fuser 122.

In some embodiments, an occlusion mask triplane may further be used during a training and/or inference phase. For example, FIG. 2D illustrates a block diagram 260 showing a training phase for training the triplane fusion architecture comprising occlusion masks, in accordance with one or more embodiments of the present disclosure. The block diagram 260 is similar to the block diagram 250 of FIG. 2C except that block diagram 260 further includes the frontal triplane pseudo-ground truth T_{frontalGT} 222, which was obtained in FIG. 2A, and the frontal groundtruth visibility triplane T_{visGT} 262, which is rasterized from the frontal triplane pseudo-ground truth T_{frontalGT} 222. For instance, in addition to providing the fuser 122 with helpful information about visibility, it may also be beneficial to emphasize the reconstruction of occluded areas during training because it may encourage the triplane fusion architecture 110 (e.g., the fuser 122) to leverage the frontal reference image for the reconstruction of occluded areas. To achieve this, an occlusion mask triplane may be used to upweight the triplane loss on occluded areas on the triplane indicated by the mask. For instance, during the training phase, the groundtruth occlusion mask T_{occMask}^{raw} ∈ [symbol] ^{3×256×256} may be calculated as the difference between the visibility triplane T_{visGT}^{raw} 254 versus the much more complete front groundtruth visibility triplane T_{visGT} 262. The groundtruth visibility triplane T_{visGT} 262 may be determined based on rasterizing the frontal triplane pseudo-ground truth T_{frontalGT} 222, which was obtained in FIG. 2A.

After calculating the occlusion mask T_{occMask}^{raw} (e.g., the occlusion mask described above), the occlusion mask T_{occMask}^{raw} may be used to calculate the fusion loss L_{fusion}. For instance, as mentioned above, the fusion loss L_{fusion} may be determined based on the Ly loss between the fused triplane T_{fused} 124 and the pseudo-groundtruth triplane T_{frontalGT} 222. Additionally, the occlusion mask T_{occMask}^{raw} may also be used to calculate the fusion loss L_{fusion}. For instance, the fusion loss L_{fusion} may upweight the occluded regions via the occlusion mask T_{occMask}^{raw}. This is shown in the below representation:

$${L}_{fusion} = Mean ( ‖ {T}_{fused} - {T}_{frontalGT} ‖ ) + \frac{Sum ( ‖ {T}_{fused} - {T}_{frontalGT} ‖ ) * {T}_{visGT}}{Sum ( {T}_{visGT} )} + \frac{Sum ( ‖ {T}_{fused} - {T}_{frontalGT} ‖ ) * {T}_{occMask}^{raw}}{sum ( {T}_{occMask}^{raw} )} \qquad ( 13 )$$

Thus, in addition to determining the difference between the fused triplane T_{fused} 124 and the pseudo-groundtruth triplane T_{frontalGT} 222, the occlusion mask T_{occMask}^{raw} and the visibility groundtruth T_{visGT} 262 may be used to calculate the fusion loss L_{fusion}.

As such, among other benefits and advantages, embodiments of the present disclosure provide may provide an undistorter 116 that removes view-dependent distortions from the raw triplane 114 by using the triplane prior 108 as a reference. Furthermore, embodiments of the present disclosure provide may provide a fuser 122 that fuses the triplanes together to recover the occluded areas in the input frame 104 by incorporating features from the triplane prior 108 that is lifted from the frontal reference image 102.

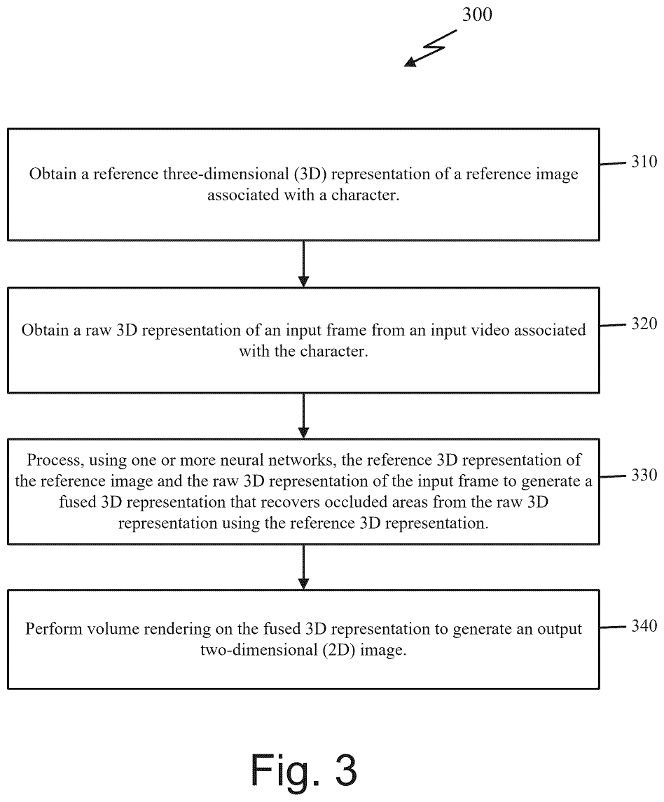

FIG. 3 illustrates a flowchart of a method 300 for using the triplane fusion architecture 110, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the triplane fusion architecture 110 of FIGS. 1B and 2A-2C. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, a reference three-dimensional (3D) representation of a reference image associated with a character (e.g., user and/or person) is obtained. In an embodiment, obtaining the reference 3D representation comprises receiving a reference image of the character acquired using a sensor and inputting the reference image into a first transformation model to transform the reference image into the reference 3D representation. In an embodiment, the reference image is a front novel view of the character. For instance, the front view may be ideal for the reference image. In another embodiment, the reference image might not be the front novel view of the character, and may instead by a side view of the character. In an embodiment, obtaining the reference 3D representation may further comprise receiving one or more additional images of the character using the sensor, and the one or more additional images are side views of the character. Further, inputting the reference image into the first transformation model comprises inputting the reference image and the one or more additional images into the first transformation model to transform the reference image and the one or more additional images into the reference 3D representation.

At step 320, a raw 3D representation of an input frame from an input video associated with the character is obtained. In an embodiment, obtaining the raw 3D representation comprises inputting the input frame into a second transformation model to transform the input frame into the raw 3D representation. The first transformation model (e.g., from step 310) and the second transformation model are Live 3D Portrait (LP3D) models. In an embodiment, the reference 3D representation and the raw 3D representation are triplane representations. The triplane representations are data structures that have four dimensions. The first and second dimensions of the triplane representations are based on a height and width of the reference image or the input frame, the third dimension is associated with a set of orthogonal planes, and the fourth dimension indicates channels of feature maps for each of the set of orthogonal planes.

At step 330, using one or more neural networks, the reference 3D representation of the reference image and the raw 3D representation of the input frame are processed to generate a fused 3D representation that recovers occluded areas from the raw 3D representation using the reference 3D representation. In an embodiment, processing the reference 3D representation of the reference image and the raw 3D representation of the input frame to generate the fused 3D representation comprises inputting the reference 3D representation and the raw 3D representation into a first neural network to generate an undistortion flow, generating an undistorted 3D representation of the input frame based on applying the undistortion flow to the raw 3D representation, and generating, using a second neural network, the fused 3D representation based on the undistorted 3D representation of the input frame. In an embodiment, the first neural network is a convolutional neural network (CNN), the undistortion flow indicates per-pixel displacements within planes of the raw 3D representation, and applying the undistortion flow to the raw 3D representation comprises altering the raw 3D representation using the undistortion flow to generate the undistorted 3D representation.

In an embodiment, generating the fused 3D representation comprises inputting the raw 3D representation, the reference 3D representation, and the undistorted 3D representation into the second neural network to combine the raw 3D representation, the reference 3D representation, and the undistorted 3D representation into the fused 3D representation. The second neural network is a transformer. In an embodiment, the first neural network is a Spatial Pyramid network (SPyNET) and the second neural network is a recurrent video restoration transformer (RVRT).

In an embodiment, processing the reference 3D representation of the reference image and the raw 3D representation of the input frame to generate the fused 3D representation further comprises inputting the reference 3D representation into a first visibility estimator to generate a predicted prior visibility triplane, inputting the raw 3D representation into a second visibility estimator to generate a predicted raw visibility triplane, and determining a predicted raw undistorted visibility triplane based on applying the undistortion flow to the predicted raw visibility triplane. Further, generating the fused 3D representation using the second neural network is further based on the predicted raw undistorted visibility triplane and the predicted prior visibility triplane. In an embodiment, generating the fused 3D representation based on the predicted raw undistorted visibility triplane and the predicted prior visibility triplane comprises concatenating the reference 3D representation and the predicted prior visibility triplane to generate a first concatenation, concatenating the undistorted 3D representation and the predicted raw undistorted visibility triplane to generate a second concatenation, and inputting the first concatenation and the second concatenation into the second neural network to generate the fused 3D representation.

At step 340, volume rendering is performed on the fused 3D representation to generate an output two-dimensional (2D) image.

In an embodiment, the method 300 may further include generating, using a synthetic data generator, a first training 3D representation and a second training 3D representation and training a fusion architecture using the first and the second training 3D representations. The fusion architecture comprises a first neural network and a second neural network. In an embodiment, the synthetic data generator comprises a random vector generator, an animated mesh generator, and a synthetic 3D representation generator. Further, generating the first training 3D representation comprises obtaining a random vector using the random vector generator, obtaining a first animated mesh of an animated character using the animated mesh generator, and inputting the random vector and the first animated mesh into the synthetic 3D representation generator to generate the first training 3D representation. The first animated mesh indicates coefficients and landmarks associated with the animated character.

In an embodiment, the first training 3D representation indicates a synthetic character having a first facial expression and the second training 3D representation indicates the same synthetic character having a second facial expression that is different from the first facial expression. In an embodiment, training the fusion architecture comprises obtaining a training reference image based on using a frontal view point of the first training 3D representation and volume rendering, obtaining a training input frame based on using a first view point of the second training 3D representation and volume rendering, and training the fusion architecture using the training reference image and the training input frame.

In an embodiment, training the fusion architecture further comprises obtaining a groundtruth novel view based on using a second view point of the second training 3D representation and volume rendering, generating a rendered novel view based on inputting the training reference image and the training input frame into the fusion architecture, and determining a rendering loss based on comparing the groundtruth novel view and the rendered novel view. The second view point and the first view point are randomly determined during each iteration of training the fusion architecture. The training the fusion architecture is based on the rendering loss.

In an embodiment, training the fusion architecture further comprises obtaining a frontal view based on a frontal view point of the second training 3D representation and volume rendering, and inputting the frontal view into a transformation model to generate a frontal 3D pseudo-ground truth representation. The training the fusion architecture is further based on the frontal 3D pseudo-ground truth representation. In an embodiment, training the fusion architecture using the training reference image and the training input frame comprises generating a training reference 3D representation and a training raw 3D representation using the training reference image and the training input frame, inputting the training reference 3D representation and the training raw 3D representation into the first neural network to determine a training undistorted 3D representation, and determining an undistorter loss based on comparing the training undistorted 3D representation with the frontal 3D pseudo-ground truth representation. In an embodiment, training the fusion architecture using the training reference image and the training input frame comprises generating a training reference 3D representation and a training raw 3D representation using the training reference image and the training input frame, generating a training fused 3D representation based on the training reference 3D representation and the training raw 3D representation, and determining a fusion loss based on comparing the training fused 3D representation with the frontal 3D pseudo-ground truth representation.

In an embodiment, the method 300 may further include generating a training reference 3D representation and a training raw 3D representation using the training reference image and the training input frame, generating a rasterized prior visibility triplane and a rasterized raw visibility triplane using the training reference 3D representation and the training raw 3D representation, and determining a visibility loss based on the rasterized prior visibility triplane and the rasterized raw visibility triplane. The training the fusion architecture is further based on using the visibility loss.

In an embodiment, at least one of steps 310-340 and/or the further steps described above for method 300 are performed on a server or in a data center to generate the output 2D image, and the output 2D image is streamed to a use device. In an embodiment, at least one of steps 310-340 and/or the further steps described above for method 300 is performed within a cloud computing environment. In an embodiment, at least one of steps 310-340 and/or the further steps described above for method 300 is performed for training, testing, or certifying a neural network employed in a machine, robot, or autonomous vehicle. In an embodiment, at least one of steps 310-340 and/or the further steps described above for method 300 is performed on a virtual machine comprising a portion of a graphics processing unit.

In some examples, embodiments of the present disclosure recognize a novel problem to enhance user experiences (e.g., the need to achieve both temporal consistency and reconstruction of dynamic appearances when using single-view 3D lifting solution for telepresence and/or other applications). To solve the problem, embodiments of the present disclosure describe a novel triplane fusion method and/or architecture (e.g., the triplane fusion architecture 110) that fuses the dynamic information from per-frame triplanes with a personal triplane prior extracted from a reference image 102. In some instances, the triplane fusion architecture 110 may be trained using a synthetic multi-view video dataset (e.g., generated using a synthetic data generator 202), and the feedforward approach from embodiments of the present disclosure may generate 3D portrait videos that demonstrate both temporal consistency and faithful reconstruction of dynamic appearances (e.g., lighting and expression) of the character at the moment, whereas conventional approaches may only achieve one of the two properties. Evaluations on both in-studio and in-the-wild datasets demonstrate that the triplane fusion architecture 110 described by one or more embodiments of the present disclosure achieves state-of-the-art performance in both temporal consistency and reconstruction accuracy. In other words, recognizing the individual limitations of per-frame single-view reconstruction and 3D reenactment methods, embodiments of the present disclosure describe the first single-view 3D lifting method to reconstruct a 3D photorealistic avatar with faithful dynamic information as well as temporal consistency, which marries the best of both worlds. In some embodiments, using triplane fusion architecture 110 described above may pave the way forward for creating a high-quality telepresence system accessible to consumers.

### Parallel Processing Architecture

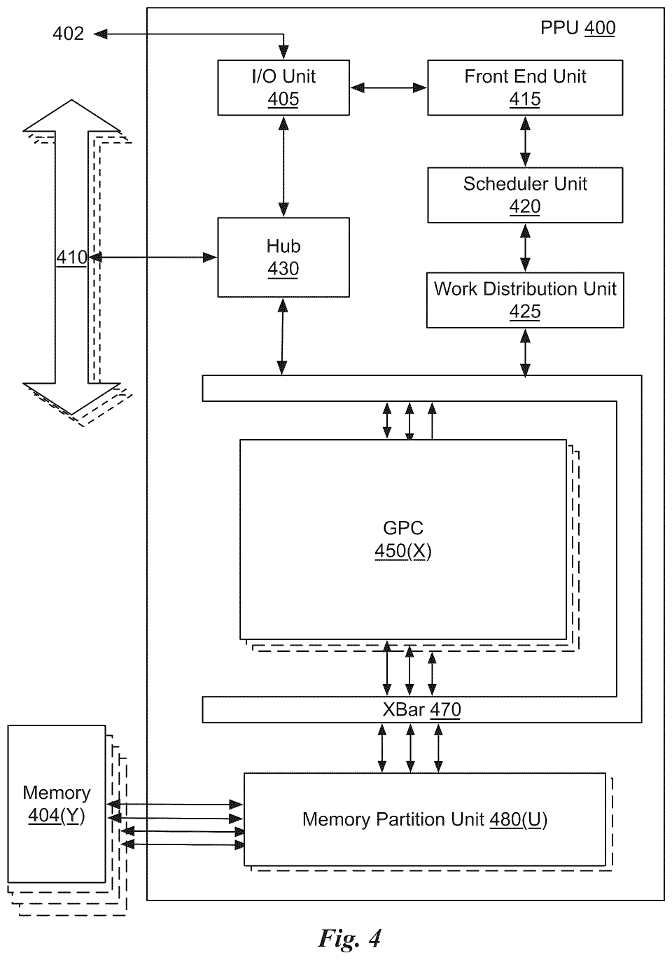

FIG. 4 illustrates a parallel processing unit (PPU) 400, in accordance with an embodiment. The PPU 400 may be used to implement the triplane fusion architecture 110 via memory propagation using dynamic synthetic data. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

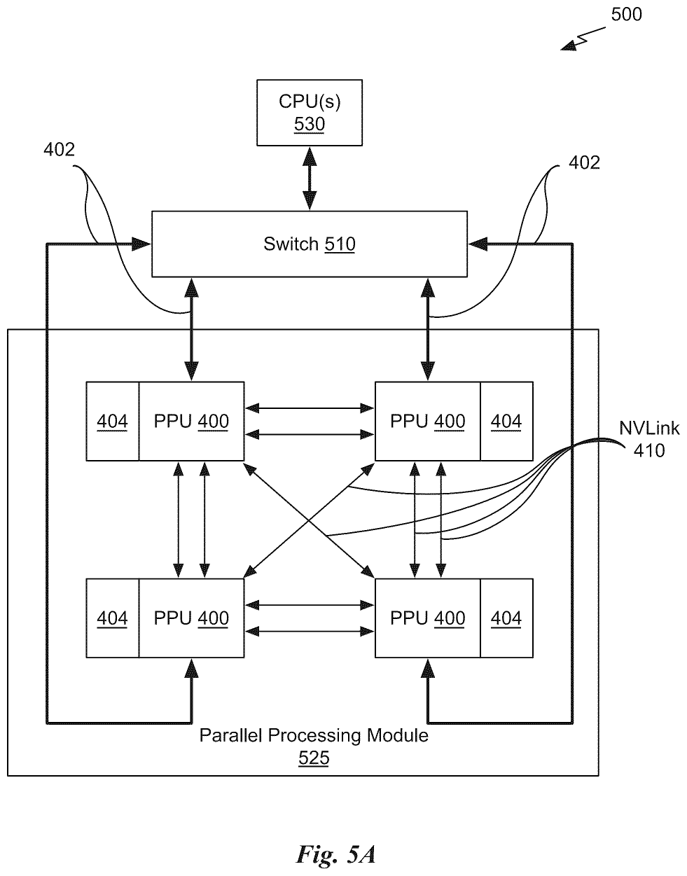

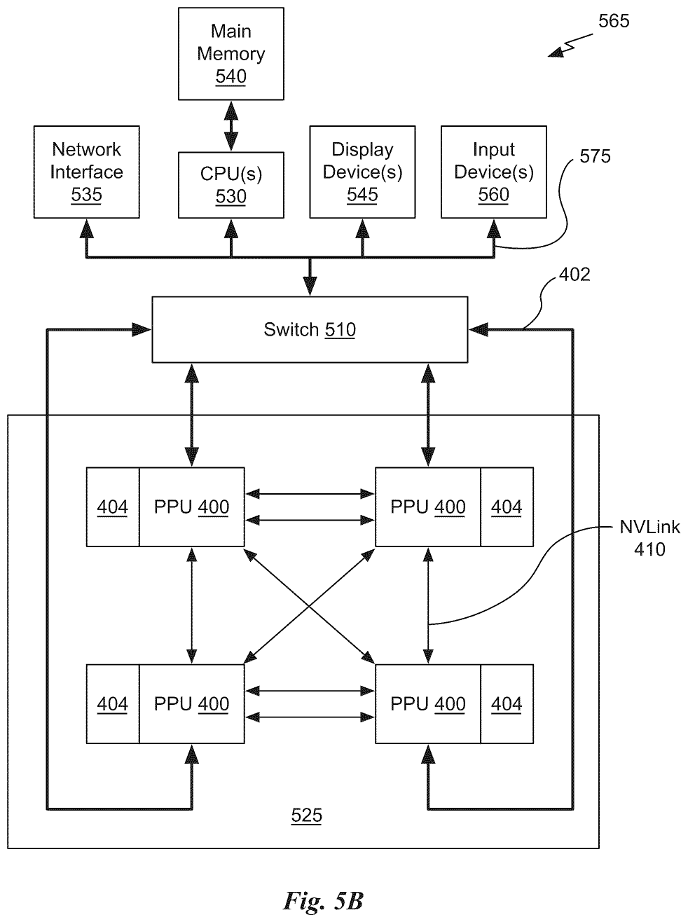

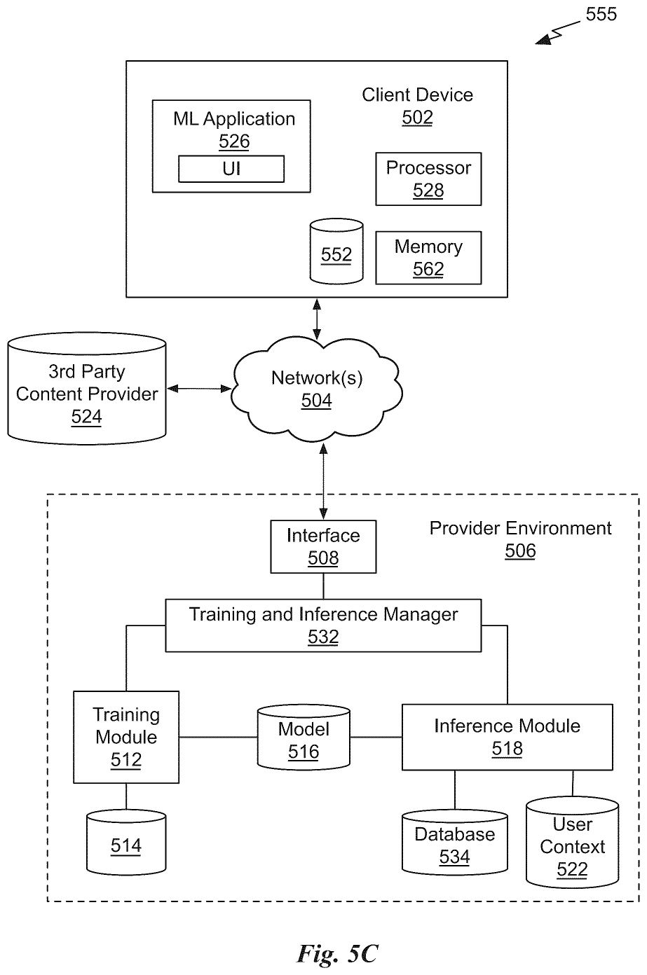

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the coherent 3D portrait reconstruction via memory propagation using dynamic synthetic data. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the coherent 3D portrait reconstruction via memory propagation using dynamic synthetic data.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUS (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache 460 and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

A graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline utilizing the hardware of the PPU 400.

Various programs may be executed within the PPU 400 in order to implement the various stages of the graphics processing pipeline. For example, the device driver may launch a kernel on the PPU 400 to perform a vertex shading stage on one processing unit (or multiple processing units). The device driver (or the initial kernel executed by the PPU 400) may also launch other kernels on the PPU 400 to perform other stages of the graphics processing pipeline, such as a geometry shading stage and a fragment shading stage. In addition, some of the stages of the graphics processing pipeline may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

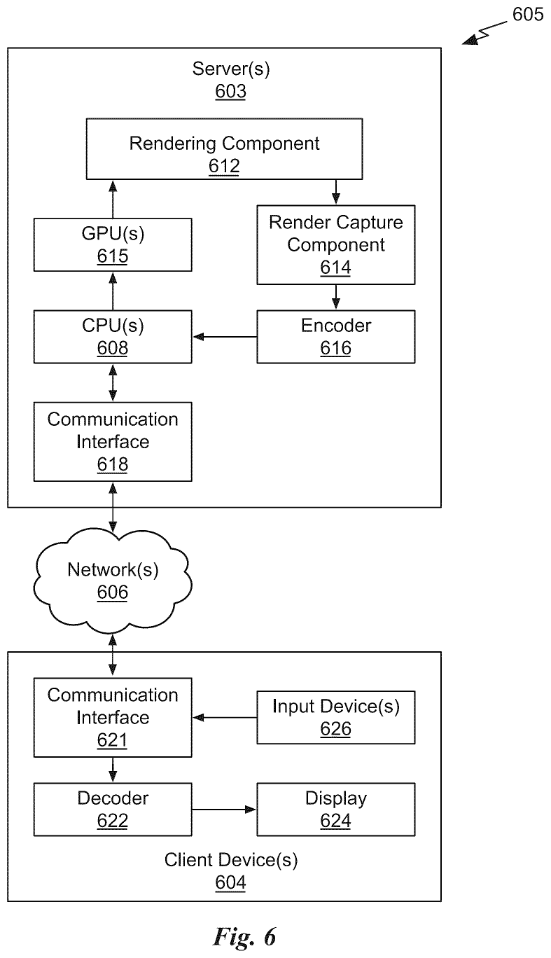

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method, comprising:
obtaining a reference three-dimensional (3D) representation of a reference image associated with a character;
obtaining a raw 3D representation of an input frame from an input video associated with the character;
processing, using one or more neural networks, the reference 3D representation of the reference image and the raw 3D representation of the input frame to generate a fused 3D representation that recovers occluded areas from the raw 3D representation using the reference 3D representation; and
performing volume rendering on the fused 3D representation to generate an output two-dimensional (2D) image.

2. The computer-implemented method of claim 1, wherein obtaining the reference 3D representation comprises:
receiving a reference image of the character using a sensor, wherein the reference image is a front novel view of the character; and
inputting the reference image into a first transformation model to transform the reference image into the reference 3D representation.

3. The computer-implemented method of claim 2, wherein obtaining the raw 3D representation comprises inputting the input frame into a second transformation model to transform the input frame into the raw 3D representation, wherein the first transformation model and the second transformation model are Live 3D Portrait (LP3D) models.

4. The computer-implemented method of claim 2, wherein obtaining the reference 3D representation further comprises:
receiving one or more additional images of the character using the sensor, wherein the one or more additional images are side views of the character, and
wherein inputting the reference image into the first transformation model comprises inputting the reference image and the one or more additional images into the first transformation model to transform the reference image and the one or more additional images into the reference 3D representation.

5. The computer-implemented method of claim 1, wherein the reference 3D representation and the raw 3D representation are triplane representations, wherein the triplane representations are data structures that have four dimensions, wherein the first and second dimensions of the triplane representations are based on a height and width of the reference image or the input frame, the third dimension is associated with a set of orthogonal planes, and the fourth dimension indicates channels of feature maps for each of the set of orthogonal planes.

6. The computer-implemented method of claim 1, wherein processing the reference 3D representation of the reference image and the raw 3D representation of the input frame to generate the fused 3D representation comprises:
inputting the reference 3D representation and the raw 3D representation into a first neural network to generate an undistortion flow;
generating an undistorted 3D representation of the input frame based on applying the undistortion flow to the raw 3D representation; and
generating, using a second neural network, the fused 3D representation based on the undistorted 3D representation of the input frame.

7. The computer-implemented method of claim 6, wherein the first neural network is a convolutional neural network (CNN), wherein the undistortion flow indicates per-pixel displacements within planes of the raw 3D representation, and wherein applying the undistortion flow to the raw 3D representation comprises:
altering the raw 3D representation using the undistortion flow to generate the undistorted 3D representation.

8. The computer-implemented method of claim 6, wherein generating the fused 3D representation comprises:
inputting the raw 3D representation, the reference 3D representation, and the undistorted 3D representation into the second neural network to combine the raw 3D representation, the reference 3D representation, and the undistorted 3D representation into the fused 3D representation, wherein the second neural network is a transformer.

9. The computer-implemented method of claim 6, wherein the first neural network is a Spatial Pyramid network (SPyNET) and the second neural network is a recurrent video restoration transformer (RVRT).

10. The computer-implemented method of claim 6, wherein processing the reference 3D representation of the reference image and the raw 3D representation of the input frame to generate the fused 3D representation further comprises:
inputting the reference 3D representation into a first visibility estimator to generate a predicted prior visibility triplane;
inputting the raw 3D representation into a second visibility estimator to generate a predicted raw visibility triplane; and
determining a predicted raw undistorted visibility triplane based on applying the undistortion flow to the predicted raw visibility triplane, and
wherein generating the fused 3D representation using the second neural network is further based on the predicted raw undistorted visibility triplane and the predicted prior visibility triplane.

11. The computer-implemented method of claim 10, wherein generating the fused 3D representation based on the predicted raw undistorted visibility triplane and the predicted prior visibility triplane comprises:
concatenating the reference 3D representation and the predicted prior visibility triplane to generate a first concatenation;
concatenating the undistorted 3D representation and the predicted raw undistorted visibility triplane to generate a second concatenation; and
inputting the first concatenation and the second concatenation into the second neural network to generate the fused 3D representation.

12. The computer-implemented method of claim 1, further comprising:
generating, using a synthetic data generator, a first training 3D representation and a second training 3D representation; and
training a fusion architecture using the first and the second training 3D representations, wherein the fusion architecture comprises a first neural network and a second neural network.

13. The computer-implemented method of claim 12, wherein the synthetic data generator comprises a random vector generator, an animated mesh generator, and a synthetic 3D representation generator, and wherein generating the first training 3D representation comprises:
obtaining a random vector using the random vector generator;
obtaining a first animated mesh of an animated character using the animated mesh generator, wherein the first animated mesh indicates coefficients and landmarks associated with the animated character; and
inputting the random vector and the first animated mesh into the synthetic 3D representation generator to generate the first training 3D representation.

14. The computer-implemented method of claim 12, wherein the first training 3D representation indicates a synthetic character having a first facial expression, and wherein the second training 3D representation indicates the same synthetic character having a second facial expression that is different from the first facial expression.

15. The computer-implemented method of claim 12, wherein training the fusion architecture comprises:
obtaining a training reference image based on using a frontal view point of the first training 3D representation and volume rendering;
obtaining a training input frame based on using a first view point of the second training 3D representation and volume rendering; and
training the fusion architecture using the training reference image and the training input frame.

16. The computer-implemented method of claim 15, wherein training the fusion architecture further comprises:
obtaining a groundtruth novel view based on using a second view point of the second training 3D representation and volume rendering, wherein the second view point and the first view point are randomly determined during each iteration of training the fusion architecture;
generating a rendered novel view based on inputting the training reference image and the training input frame into the fusion architecture; and
determining a rendering loss based on comparing the groundtruth novel view and the rendered novel view, and wherein training the fusion architecture is based on the rendering loss.

17. The computer-implemented method of claim 15, wherein training the fusion architecture further comprises:
obtaining a frontal view based on a frontal view point of the second training 3D representation and volume rendering; and
inputting the frontal view into a transformation model to generate a frontal 3D pseudo-ground truth representation, wherein training the fusion architecture is further based on the frontal 3D pseudo-ground truth representation.

18. The computer-implemented method of claim 17, wherein training the fusion architecture using the training reference image and the training input frame comprises:
generating a training reference 3D representation and a training raw 3D representation using the training reference image and the training input frame;
inputting the training reference 3D representation and the training raw 3D representation into the first neural network to determine a training undistorted 3D representation; and
determining an undistorter loss based on comparing the training undistorted 3D representation with the frontal 3D pseudo-ground truth representation.

19. The computer-implemented method of claim 17, wherein training the fusion architecture using the training reference image and the training input frame comprises:
generating a training reference 3D representation and a training raw 3D representation using the training reference image and the training input frame;
generating a training fused 3D representation based on the training reference 3D representation and the training raw 3D representation; and
determining a fusion loss based on comparing the training fused 3D representation with the frontal 3D pseudo-ground truth representation.

20. The computer-implemented method of claim 15, further comprising:
generating a training reference 3D representation and a training raw 3D representation using the training reference image and the training input frame;
generating a rasterized prior visibility triplane and a rasterized raw visibility triplane using the training reference 3D representation and the training raw 3D representation; and
determining a visibility loss based on the rasterized prior visibility triplane and the rasterized raw visibility triplane, and
wherein training the fusion architecture is further based on using the visibility loss.

21. The computer-implemented method of claim 1, wherein at least one of the steps of obtaining, processing and performing are performed on a server or in a data center to generate the output 2D image, and the output 2D image is streamed to a user device.

22. The computer-implemented method of claim 1, wherein at least one of the steps of obtaining, processing and performing are performed within a cloud computing environment.

23. The computer-implemented method of claim 1, wherein at least one of the steps of obtaining, processing and performing are performed for training, testing, or certifying a neural network employed in a machine, robot, or autonomous vehicle.

24. The computer-implemented method of claim 1, wherein at least one of the steps of obtaining, processing and performing is performed on a virtual machine comprising a portion of a graphics processing unit.

25. A system, comprising:
one or more processors; and
a non-transitory computer-readable medium having processor-executable instructions stored thereon, wherein the processor-executable instructions, when executed by the one or more processors, facilitate:
obtaining a reference three-dimensional (3D) representation of a reference image associated with a character;
obtaining a raw 3D representation of an input frame from an input video associated with the character;
processing, using one or more neural networks, the reference 3D representation of the reference image and the raw 3D representation of the input frame to generate a fused 3D representation that recovers occluded areas from the raw 3D representation using the reference 3D representation; and
performing volume rendering on the fused 3D representation to generate an output two-dimensional (2D) image.

26. The system of claim 25, wherein obtaining the reference 3D representation comprises:
receiving a reference image of the character using a sensor, wherein the reference image is a front novel view of the character; and
inputting the reference image into a first transformation model to transform the reference image into the reference 3D representation.

27. A non-transitory computer-readable medium having processor-executable instructions stored thereon, wherein the processor-executable instructions, when executed, facilitate:
obtaining a reference three-dimensional (3D) representation of a reference image associated with a character;
obtaining a raw 3D representation of an input frame from an input video associated with the character;
processing, using one or more neural networks, the reference 3D representation of the reference image and the raw 3D representation of the input frame to generate a fused 3D representation that recovers occluded areas from the raw 3D representation using the reference 3D representation; and
performing volume rendering on the fused 3D representation to generate an output two-dimensional (2D) image.

28. The non-transitory computer-readable medium of claim 27, wherein obtaining the reference 3D representation comprises:
receiving a reference image of the character using a sensor, wherein the reference image is a front novel view of the character; and
inputting the reference image into a first transformation model to transform the reference image into the reference 3D representation.
